(19) United States
(12) Patent Application Publication
(10) Pub. No.: US 2024/0249045 A1
(43) Pub. Date: Jul. 25, 2024

(54) METHODS AND APPARATUS TO PREDICT POWER CONSUMPTION

(71) Applicant: VMware LLC, Palo Alto, CA (US)

(72) Inventors: Yixing Jia, Beijing (CN); Gavin Lu, Beijing (CN); Mark Peek, Anacortes, WA (US); Wenbin Xu, Beijing (CN)

(21) Appl. No.: 18/186,059

(22) Filed: Mar. 17, 2023

Related U.S. Application Data
(63) Continuation of application No. PCT/CN2023/000022, filed on Jan. 20, 2023.

(51) Int. Cl. G06F 30/27

(52) U.S. Cl. CPC G06F 30/27

(57) ABSTRACT

Methods, apparatus, systems, and articles of manufacture are disclosed to predict power consumption in a server. An example apparatus includes interface circuitry to obtain a power prediction request corresponding to the server range determiner circuitry to divide a training data set into a first sub-range of data and a second sub-range of the data; a data point in the training data set representative of resource utilization of a workload and a corresponding power consumption metric of the workload; model trainer circuitry to train first candidate models based on the first sub-range of the data and second candidate models based on the second sub-range of the data; and prediction selector circuitry to: select a first prediction model from the first candidate models; and select a second prediction model from the second candidate models, outputs of the first and the second prediction models to predict the power consumption of the server.

### RELATED APPLICATION

This patent arises from a continuation of International Application No. PCT/CN2023/000022, which was filed on Jan. 20, 2023. International Application No. PCT/CN2023/000022 is hereby incorporated herein by reference in its entirety. Priority to International Application No. PCT/CN2023/000022 is hereby claimed.

### FIELD OF THE DISCLOSURE

This disclosure relates generally to machine learning and, more particularly, to methods and apparatus to predict power consumption.

### BACKGROUND

In recent years, a rise in the complexity and number of workloads executed by computing devices has led to a corresponding increase in power consumption. As a result, both knowing the current power consumption of a computing device and predicting the future power consumption of the computing device has become increasingly relevant. For example, a data center with accurate knowledge of current and future power consumption metrics may use the knowledge to assign workloads more efficiently. Such changes can reduce the total power consumption of the data center, thereby reducing electricity costs and improving sustainability efforts.

### BRIEF DESCRIPTION OF THE DRAWINGS

FIG. 1 is an example system to predict the power consumption of servers in a data center.

FIG. 2 is a block diagram of the example power predictor circuitry of FIG. 1.

FIG. 3 is a graph illustrating historical workloads of a server from the data center of FIG. 1.

FIGS. 4A and 4B are graphs illustrating models of resource utilization and power consumption based exclusively on historical workloads.

FIG. 5 is a graph illustrating power consumption data obtained from a manufacturer.

FIG. 6 is a graph illustrating a data set of resource utilization and power consumption formed by a baseline model circuitry of FIG. 2.

FIGS. 7A and 7B are graphs illustrating a data set of resource utilization and power consumption before and after modifications by the workload model circuitry of FIG. 2.

FIG. 8 is a flowchart representative of example machine readable instructions and/or example operations that may be executed by example processor circuitry to implement the data center power manager of the central facility of FIG. 1.

FIG. 9 is a flowchart representative of example machine readable instructions and/or example operations that may be executed by example processor circuitry to implement the power predictor circuitry of FIGS. 1 and 2.

FIG. 10 is a flowchart representative of example machine readable instructions and/or example operations that may be executed by example processor circuitry to implement the baseline model circuitry of FIG. 2.

FIG. 11 is a flowchart representative of example machine readable instructions and/or example operations that may be executed by example processor circuitry to implement the model trainer circuitry of FIG. 2.

FIG. 12 is a flowchart representative of example machine readable instructions and/or example operations that may be executed by example processor circuitry to implement the model executor circuitry and prediction selector circuitry of FIG. 2.

FIG. 13 is a block diagram of an example processing platform including processor circuitry structured to execute the example machine readable instructions and/or the example operations of FIGS. 8-12 to implement the data center power manager of FIG. 1 and/or the power predictor circuitry of FIG. 2.

FIG. 14 is a block diagram of an example implementation of the processor circuitry of FIG. 13.

FIG. 15 is a block diagram of another example implementation of the processor circuitry of FIG. 13.

FIG. 16 is a block diagram of an example software distribution platform (e.g., one or more servers) to distribute software (e.g., software corresponding to the example machine readable instructions of FIGS. 8-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to an occurrence within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

As both sustainability efforts and the complexity of computing workloads grow across a variety of industries, a need for accurate power consumption data has emerged. One technique to predict power consumption is to develop a machine learning (ML) model. Such a ML model may be developed by using previous workloads and corresponding power consumption metrics as training data. ML models can use the training data to characterize relationships between workload data and power consumption metrics. Once trained, an ML model may apply the characterization to a description of a future workload and produce an estimate of how much power a compute device will consume when executing the future workload.

Previous solutions that employ a limited number of ML models may fail to output accurate power prediction results in some environments. For example, a data center may include hundreds or thousands of individual compute devices. The compute devices could include a variety of products produced by a variety of manufacturers. Manufacturers frequently design devices with unique sets of compute resources and configurations to distinguish products from one another in the marketplace. As a result, any two compute devices in a data center may be designed to consume different amounts of power when executing the same workload.

In addition to designed differences in performance between different products, the actual power consumption from two instances of the same product (e.g., two compute devices that have the same name, model number, manufacturer, etc.) may differ between environments. For example, factors that include but are not limited to external temperature, the amount of ventilation in a room, number of compute devices in a room, and the heating, ventilation and air conditioning (HVAC) capabilities of a room may affect the total amount of heat surrounding a compute device. Such environmental conditions may cause a ML model trained on a first instance of a product to be unable to accurately predict power consumption for a second instance of the same product. In some examples, other factors such as the age of a compute device may additionally contribute to power consumption differences between two instances of the same product.

In some solutions, the accuracy of power consumption predictions may also be limited by the type of ML model used. A variety of ML model types can be used to predict the power consumption of a compute device. Such model types may include, but are not limited to, convolutional neural networks (CNNs), support vector machines (SVMs), random forest classifiers, n-dimensional polynomial regression, multi-variable power equations, etc. A given model type may characterize the relationship between historical workload data and recorded power consumption metrics more accurately for some products than the model type does for other products.

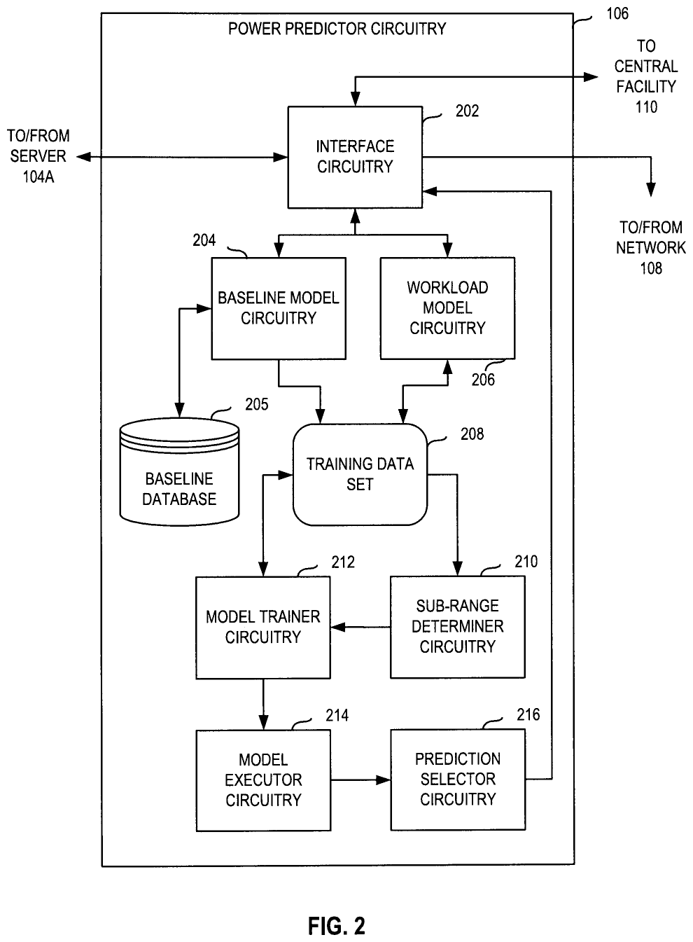

Effective model types may additionally vary power predictions of a single compute device. A given compute device has a range of possible workloads that the compute device can execute. Within that range, a given model type may characterize one sub-range of workloads more accurately than a second sub-range of workloads. Additionally, some sub-ranges of workloads may have less corresponding historical workload data than other sub-ranges of workloads. As a result, ML models trained on data from a limited number of sub-ranges may struggle to accurately predict power consumption across the full range of all possible workloads. Sub-ranges are discussed further in connection with FIGS. 2-7B.

Examples herein provide accurate power predictions for a plurality of compute devices in a timely and efficient manner. Example power predictor circuitry obtains workload data from a plurality of compute devices in an environment such as a data center. The example power predictor circuitry produces a set of prediction models for each compute device in the data center. Specifically, the example power predictor circuitry divides the range of all possible workloads for a given device into sub-ranges and produces a prediction model for each sub-range.

To generate a prediction model, the example power predictor circuitry first generates a set of candidate models using training data from a specific sub-range. In some examples, training a model using training data from a specific sub-range is referred to tuning a model to the sub-range. The power predictor circuitry selects the candidate model with the lowest error as the power prediction model for the particular sub-range. As a result, examples disclosed herein can produce a prediction model that generates power consumption estimates for a specific sub-range of a specific compute device. Advantageously, the specific characterization of the example prediction models lead to more accurate power consumption estimates than other ML models that use a more general characterization of multiple compute device performance profiles.

To generate candidate models, the example power prediction circuitry trains models based on both historical workload data and extrapolated performance data from manufacturers. As a result, the example power prediction circuitry can generate accurate power prediction models for all sub-ranges of a compute device, even if a particular sub-range (i.e., a particular type) of workload data has not been executed frequently by the device and lacks historical data.

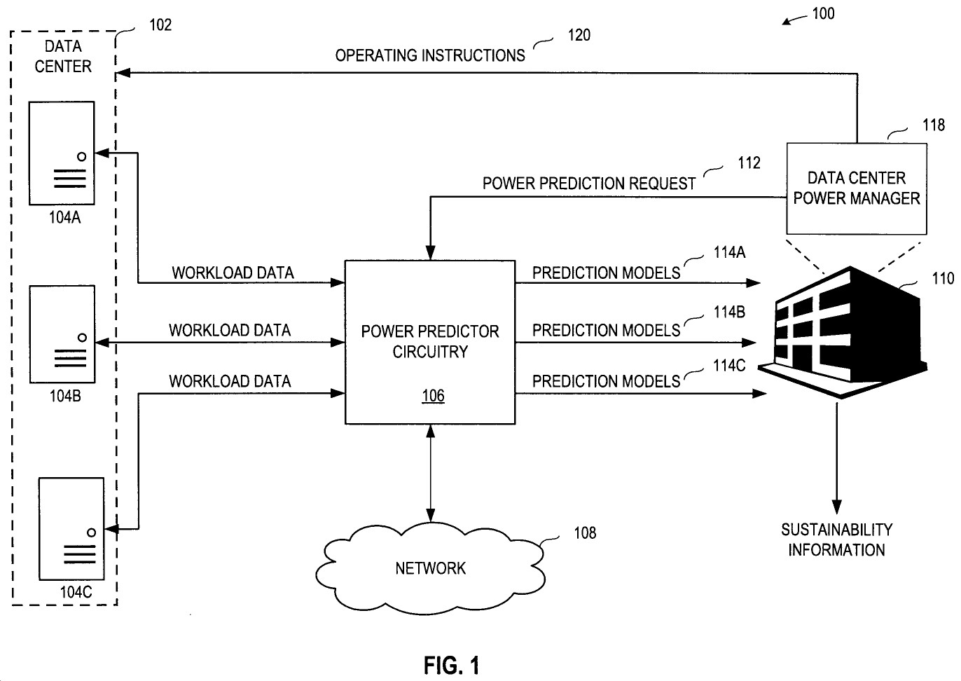

FIG. 1 is an example environment to predict the power consumption of servers in an example data center 102. The example environment 100 includes the example data center 102, which contains example servers 104A, 104B, 104C. The example environment 100 also includes example power predictor circuitry 106, an example network 108, an example central facility 110, an example power prediction request 112, and example prediction models 114A, 114B, 114C. The example central facility 110 also includes a data center power manager 118 and operating instructions 120.

The example data center 102 refers to a location that hosts a set of compute devices. While a single data center 102 is displayed in FIG. 1, the example environment 100 may include any number of data centers.

In FIG. 1, the example data center 102 is shown with three servers 104A, 104B, 104C for simplicity. However, the example data center 102 may include any number of servers. For example, a business may host tens of thousands of individual servers at a given location. The example servers 104A, 104B, 104C may provide any type of functionality. Example server types include, but are not limited to, proxy servers, mail servers, web servers, application servers, FTP servers, real-time communication servers, and virtual servers. To provide a function, an example server 104A may contain any number and any type of physical and/or virtual resources. In addition, the example data center 102 may additionally or alternatively contain compute devices that are not used within a client-server model.

The example power predictor circuitry 106 develops prediction models according to teachings of this disclosure. In particular, models produced by the example power predictor circuitry 106 estimate future power consumption of devices in the data center 102. A given model produced by the example power predictor circuitry 106 is developed to predict the power consumption of a specific device in the data center 102 when executing a specific sub-range of workloads. For example, the prediction models 114A refer to a first set of models that all predict the power consumption for the server 104A. Within the prediction models 114A, a first prediction model predicts power consumption for a first sub-range of workloads executable by the server 104A and a second prediction model predicts power consumption for a second sub-range of workloads for the server 104A. Similarly, the example prediction models 114B are a second set of models that predict power consumption of the server 104B and the prediction models 114C are a third set of models that predict power consumption of the server 104C. Prediction models and sub-ranges are discussed further below in connection with FIGS. 2-7B.

The example network 108 connects and facilitates communication between the example power predictor circuitry 106 and computer device manufacturers. While not illustrated in FIG. 1, the example network 108 may additionally connect and facilitate communication between the power predictor circuitry 106, the data center 102, and the central facility 110. In this example, the network 108 is the Internet. However, the example network 108 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The example central facility 110 refers to any entity that desires power consumption estimates for the data center 102. To obtain power consumption estimates and manage power-related operations of the data center 102, the example central facility 110 includes an example data center power manager 118. The example data center power manager 118 may be implemented using a sever or any other suitable computing device. In example FIG. 1, the data center power manager 118 provides a power prediction request 112 to the example power predictor circuitry 106. The power prediction request 112 may include a request for models corresponding to any subset of compute devices and sub-ranges in the data center 102. The example power predictor circuitry 106 generates ones of the prediction models 114A, 114B, 114C according to the power prediction request 112. The example prediction models 114A, 114B, 114C are then executed by the central facility 110 to obtain the desired power consumption estimates.

In examples described herein, the power prediction request 112 causes the power predictor circuitry 106 to generate ones of the prediction models 114A, 11B, 114C. In other examples, the power predictor circuitry 106 generates the prediction models 114A, 114B, 114C asynchronously and before the power prediction requests 112. In such examples, the power prediction request 112 only specifies which of prediction models 114A, 114B, 114C should be provided to the central facility 110 for execution.

The example central facility 110 may use the power consumption estimates for any reason. In some examples, the central facility 110 may use the power consumption estimates to develop or modify operating instructions 120 for the data center 102, causing ones of the servers 104A, 104B, 104C to operate different types and/or numbers of workloads. Additionally or alternatively, the example central facility 110 may determine sustainability information using the power consumption estimates. For example, the sustainability information may describe what changes, if any, are needed so the data center 102 consumes less than a threshold amount of power per unit of time. While the example central facility 110 is illustrated as a single entity in FIG. 1, in practice, the central facility 110 may refer to any number of locations and organizations.

The example power predictor circuitry 106 of FIG. 1 generates power prediction models that are specific to a particular server and sub-range of workloads within the data center 102. As a result, the example power predictor circuitry 106 may produce more accurate power consumption predictions than other solutions that would employ fewer numbers of models and/or fewer types of models for the data center 102. Furthermore, the increased accuracy of the example prediction models 114A, 114B, 114C may enable the central facility 110 to produce operating instructions 120 and/or sustainability information that results in lower power consumption, operating costs, and emissions from the data center 102.

FIG. 2 is a block diagram of the example power predictor circuitry 106 to generate power prediction models. The example power predictor circuitry 106 of FIG. 2 may be instantiated (e.g., creating an instance of, bring into being for any length of time, materialize, implement, etc.) by processor circuitry such as a central processing unit executing instructions. Additionally or alternatively, the power predictor circuitry 106 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers. The example power predictor circuitry 106 includes example interface circuitry 202, example baseline model circuitry 204, an example baseline database 205, example workload model circuitry 206, an example training data set 208, example sub-range determiner circuitry 210, example model trainer circuitry 212, example model executor circuitry 214, and example prediction selector circuitry 216.

The example interface circuitry 202 enables the other components of the power predictor circuitry 106 to communicate with the example servers 104A, 104B, 104C, the network 108, and the central facility 110. For example, the interface circuitry 202 may receive the power prediction request 112 from the central facility 110 and provide the power prediction request 112 to both the baseline model circuitry 204 and the workload model circuitry 206. In examples disclosed herein, the power prediction request 112 is a request for models that predict an entire range of workloads for the example server 104A. In other examples, the power prediction request 112 specify select ones of a plurality of sub-ranges in a range and/or select ones of the servers 104A, 104B, 104C in the data center 102.

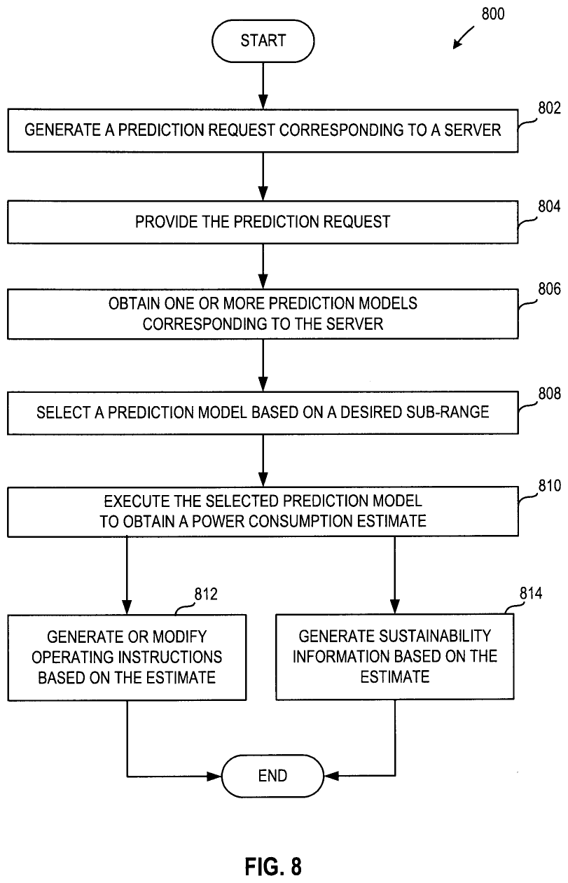

The example interface circuitry 202 may implement any type of transceiver circuitry required to support any number of wired and wireless communication protocols. In some examples, the interface circuitry 202 is instantiated by processor circuitry executing interface instructions and/or configured to perform operations such as those represented by the flowcharts of FIGS. 8-12.

The example baseline model circuitry 204 obtains the power prediction request 112 and generates an initial version of the training data set 208 based on the request. The initial version of the example training data set 208 generated by the baseline model circuitry 204 is not based on the historical workload data of the server 104A. Rather, the initial version of the training data set 208 corresponding to the server 104A is based on manufacturing data corresponding to the server 104A. In some examples the initial version of the training data set 208 may be referred to as a baseline model.

The example baseline database 205 contains a set of manufacturing data for each unique compute device product in the data center 102. For example, suppose the server 104A is a Dell® PowerEdge R650 Rack Server, the server 104B is also a Dell® PowerEdge R650 Rack Server, and the server 104C is a Dell® PowerEdge R940xa Rack Server. In such examples, the baseline database 205 may include a first set of manufacturing data corresponding to Dell® PowerEdge R650 Rack Servers and a second set of manufacturing data corresponding to Dell® PowerEdge R940xa Rack Servers. In some examples, a set of manufacturing data corresponding to a specific compute device product is referred to as a product data set.

The example baseline database 205 is implemented by any memory, storage device and/or storage disc for storing data such as, for example, flash memory, magnetic media, optical media, solid state memory, hard drive(s), thumb drive(s), etc. Furthermore, the data stored in the example baseline database 205 may be in any data format such as, for example, binary data, comma delimited data, tab delimited data, structured query language (SQL) structures, etc. While, in the illustrated example, the example baseline database 205 is illustrated as a single device, the example baseline database 205 and/or any other data storage devices described herein may be implemented by any number and/or type(s) of memories.

To generate the initial version of the training data set 208, the example baseline model circuitry 204 first identifies the compute product specified in the prediction request 112 and determines whether the example baseline database 205 includes a corresponding baseline data set. If the example baseline database 205 includes the corresponding product data set (e.g., in the foregoing example, if the power predictor circuitry 106 processes a second prediction request 112 corresponding the server 104B after previously processing a first prediction request 112 corresponding to the server 104A), the example baseline model circuitry 204 uses a copy of the corresponding product data set to generate an initial version of the training data set 208.

If the example baseline database 205 does not include a corresponding product data set, the baseline model circuitry 204 causes the example interface circuitry 202 to obtain manufacturing data from the network 108. In such examples, (e.g., the foregoing example if the power predictor circuitry processes a prediction request 112 corresponding to the server 104C) the baseline model circuitry 204 uses the obtained manufacturing data to generate the initial version of the training data set 208. In such examples, the baseline model circuitry 204 also stores a copy of the obtained manufacturing data as a new product data set in the baseline database 205. By adding a new product data set to the example baseline database 205, the example power predictor circuitry 106 no longer requires access to the network 108 for any prediction model generation corresponding to the same product (e.g., an example server 104D that is also a Dell® PowerEdge R940xa Rack Server). As used herein, manufacturing data refers to power consumption metrics for a particular compute device product that come from a source external to the environment 100. The example interface circuitry 202 may use the network 108 to obtain the manufacturing data from a website, a data sheet, or a similar source that is published or managed by an organization that designs, manufactures, and/or generally produces the compute device product. In some examples, the power predictor circuitry 106 is unable to access the network 108 on demand. In such examples, the baseline model circuitry 204 may cause the interface circuitry 202 to obtain manufacturing data for all compute devices in the data center 102 in a batch once access to the network 108 is available.

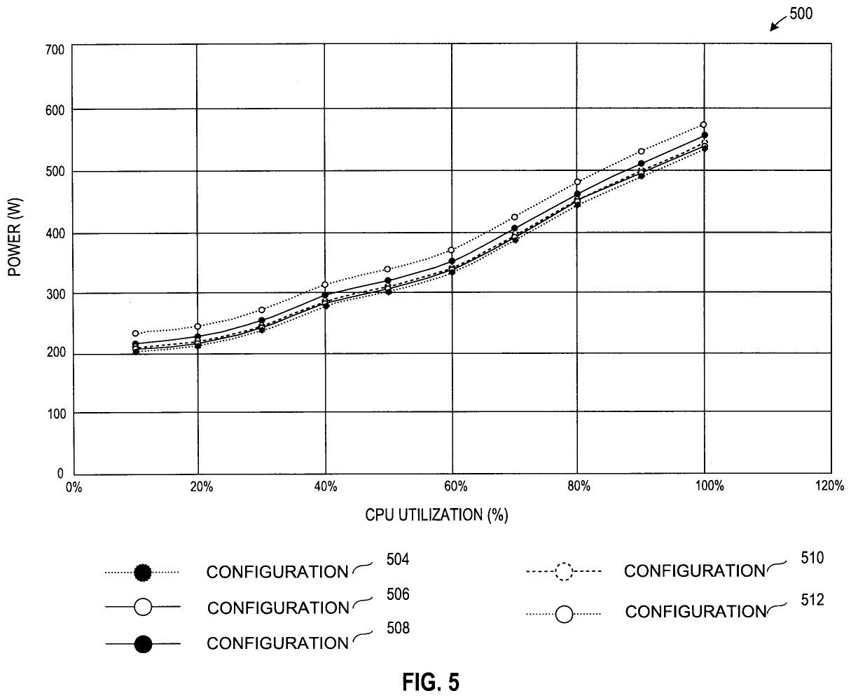

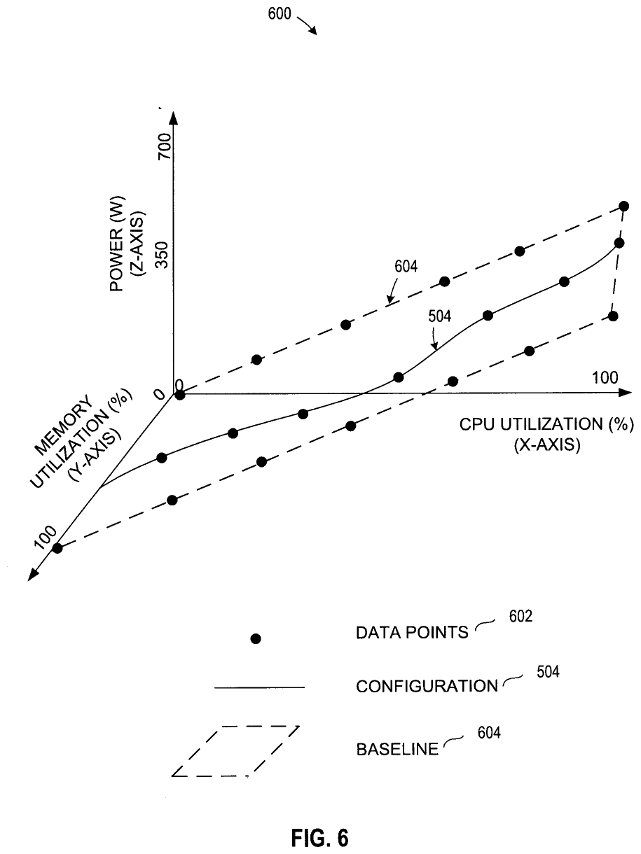

Generally, manufacturers only publish power consumption metrics of a small subset of all possible workloads that the compute device product is capable of executing. As a result, the example baseline model circuitry 204 extrapolates the product data set (obtained either from the baseline database 205 or directly from the network 108) to produce additional data points. The product data set and the additional extrapolated data, which collectively form the initial version of the training data set 208, include power consumption metrics that span across the entire range of possible workloads for the given compute device product. Manufacturing data and baseline model extrapolation are further discussed below in connection with FIGS. 5 and 6. In some examples, the baseline model circuitry 204 is instantiated by processor circuitry executing baseline model instructions and/or configured to perform operations such as those represented by the flowcharts of FIGS. 8-12.

The example workload model circuitry 206 obtains the power prediction request 112 and modifies the training data set 208 based on the request. To modify the training data set 208, the example workload model circuitry 206 first causes the interface circuitry 202 to obtain historical workload data from the server 104A. The example workload model circuitry 206 then replaces a subset of data points from the training data set 208 with historical workload data. As used herein, historical workload data refers to recorded power consumption metrics from an actual workload that was previously executed by a particular compute device. In some examples, the workload model circuitry 206 is instantiated by processor circuitry executing workload model instructions and/or configured to perform operations such as those represented by the flowcharts of FIGS. 8-12.

The example training data set 208 is a set of data points that are used to train the prediction models 114A. For example, a data point in the training data set 208 is representative of resource utilization of a workload and a corresponding power consumption metric of the workload. As described above, the example training data set 208 is first generated by the baseline model circuitry 204 and then modified by the workload model circuitry 206. The example training data set 208 may be stored in any type of memory within the power predictor circuitry 106. For example, the training data set 208 may be stored in a volatile memory or a non-volatile memory. The volatile memory may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory may be implemented by flash memory and/or any other desired type of memory device. In examples where the power prediction request 112 includes a request for two or more of the servers 104A, 104B, 104C, the example power predictor circuitry 106 develops a separate instance of the example training data set 208 for each requested server and stores the separate instances in memory.

The example sub-range determiner circuitry 210 determines the number of sub-ranges that will be used to model the power consumption of the server 104A. The example sub-range determiner circuitry 210 also assigns each of the datapoints in the modified version of the training data set 208 to one of the sub-ranges. As a result, a given sub-range refers to a set of training data points that correspond to similar workloads for a particular compute device. The example sub-range determiner circuitry 210 may divide the total range of workloads into any number of sub-ranges.

In some examples, the number of sub-ranges may be based on the amount and distribution of data in the example training data set 208. For example, the sub-range determiner circuitry 210 may divide the range such that each sub-range includes a threshold number of data points. By maintaining a minimum number of data points per sub-range, the sub-range determiner circuitry 210 may ensure a minimum level of accuracy across the models for all sub-ranges due to the linear relationship between the amount of training data and the accuracy of a model. In some examples, the sub-range determiner circuitry 210 is instantiated by processor circuitry executing range determiner instructions and/or configured to perform operations such as those represented by the flowcharts of FIGS. 8-12.

The example model trainer circuitry 212 trains candidate models to predict power consumption. To do so, the example model trainer circuitry 212 first obtains a subset of the training data set 208 as defined by the sub-range determiner circuitry 210. That is, any one subset of data points obtained by the example model trainer circuitry 212 contains all of the data points that form one sub-range. The example model trainer circuitry 212 then uses the one sub-range of the training data set 208 to train one more candidate models. The candidate models may include or be based on any suitable function(s) or algorithm(s) that, given a description of a workload, can estimate the amount of power required to execute the workload.

The example model trainer circuitry 212 trains a set of candidate models for each sub-range of the training data set 208 defined by the sub-range determiner circuitry 210. For example, if the sub-range determiner circuitry 210 divides the training data set 208 of the server 104A into five sub-ranges, and there are four different model types that may be used to predict power consumption, the model trainer circuitry 212 generates a total of twenty unique candidate models. In other examples, the model trainer circuitry 212 alternatively generates a non-uniform number of candidate models per sub-range. In some examples, the model trainer circuitry 212 is instantiated by processor circuitry executing model trainer instructions and/or configured to perform operations such as those represented by the flowcharts of FIGS. 8-12.

The example model executor circuitry 214 executes the candidate models produced by the model trainer circuitry 212. To execute a given candidate model, the example model executor circuitry 214 obtains descriptions of multiple workloads that are included in the sub-range corresponding to the candidate model. The example model executor circuitry 214 then implements the function(s) or algorithm(s) defined by the candidate model that accepts the workload description information as an input and generates an estimated power consumption metric as an output. In some examples, the model executor circuitry 214 is instantiated by processor circuitry executing prediction selector instructions and/or configured to perform operations such as those represented by the flowcharts of FIGS. 8-12.

The example prediction selector circuitry 216 selects, for a given sub-range, one model from the set of candidate models. For example, if there are twenty total candidate models, and the prediction selector circuitry 216 makes five selections, each of the five selections in the example are from a mutually exclusive set of four candidate models. The five selections collectively form the prediction models 114A, which the prediction selector circuitry 216 provides to the central facility 110 via the interface circuitry 202.

To select one model from a set of candidate models, the prediction selector circuitry 216 compares the output of the candidate models (i.e., the estimated power consumption metrics from the model executor circuitry 214) and compares the outputs to an expected result to determine which model has the lowest error. In some examples, the prediction selector circuitry 216 is instantiated by processor circuitry executing prediction selector instructions and/or configured to perform operations such as those represented by the flowcharts of FIGS. 8-12.

A wide variety of functions, algorithms, and techniques may be deployed to estimate power consumption of a compute device. Because the various functions and algorithms have different strengths and weaknesses, a given model may be more accurate predicting power consumption for some sub-ranges of workload data than others, even if the multiple workloads all correspond to the same compute device. Advantageously, the example power predictor circuitry 106 divides the range of all possible workloads into sub-ranges and evaluates multiple candidate models for a given sub-range to find the optimal model, thereby increasing accuracy across the entire range. Furthermore, the example power predictor circuitry 106 trains the candidate models using a training data set 208 with both manufacturing (i.e., baseline) data and historical workload data. As a result, the candidate models are trained using data that is both specific to a particular compute device (e.g., the server 104A) and spans across the entire range of possible workloads.

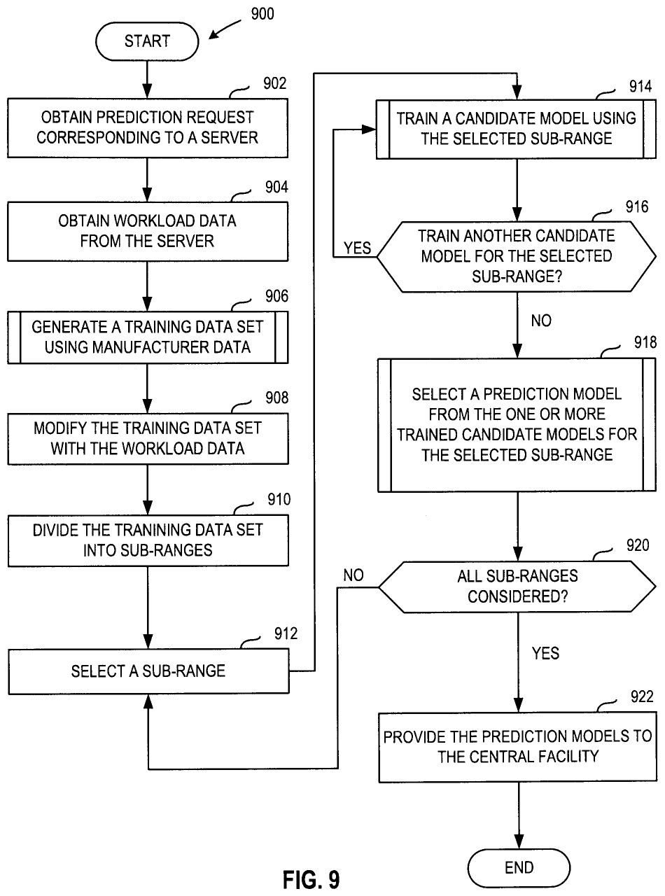

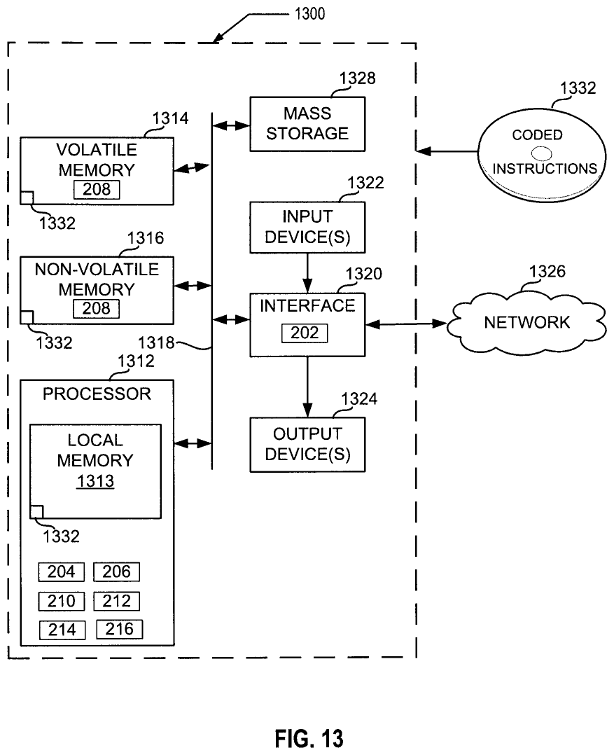

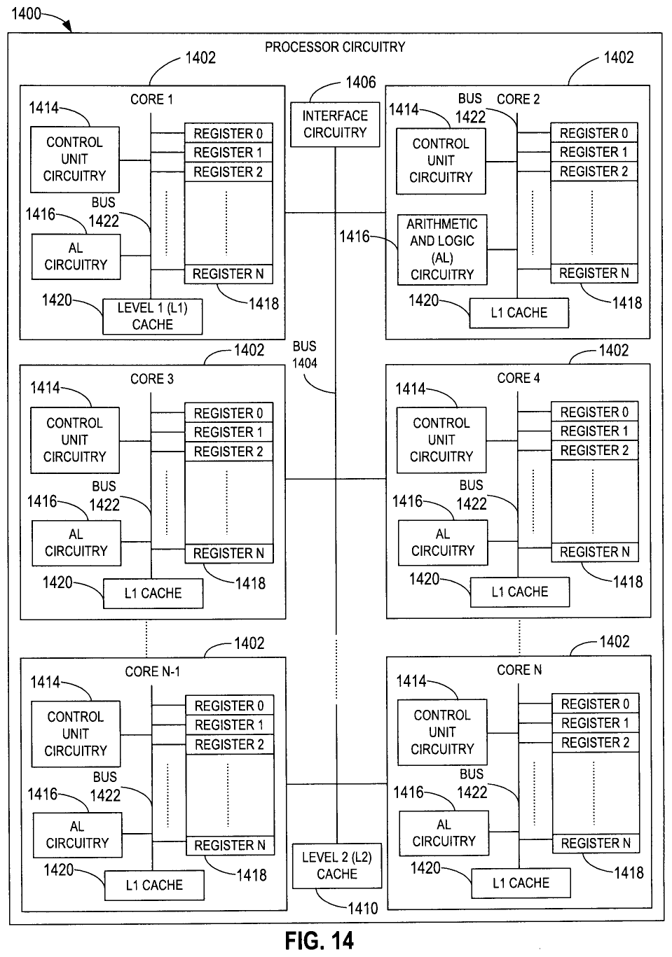

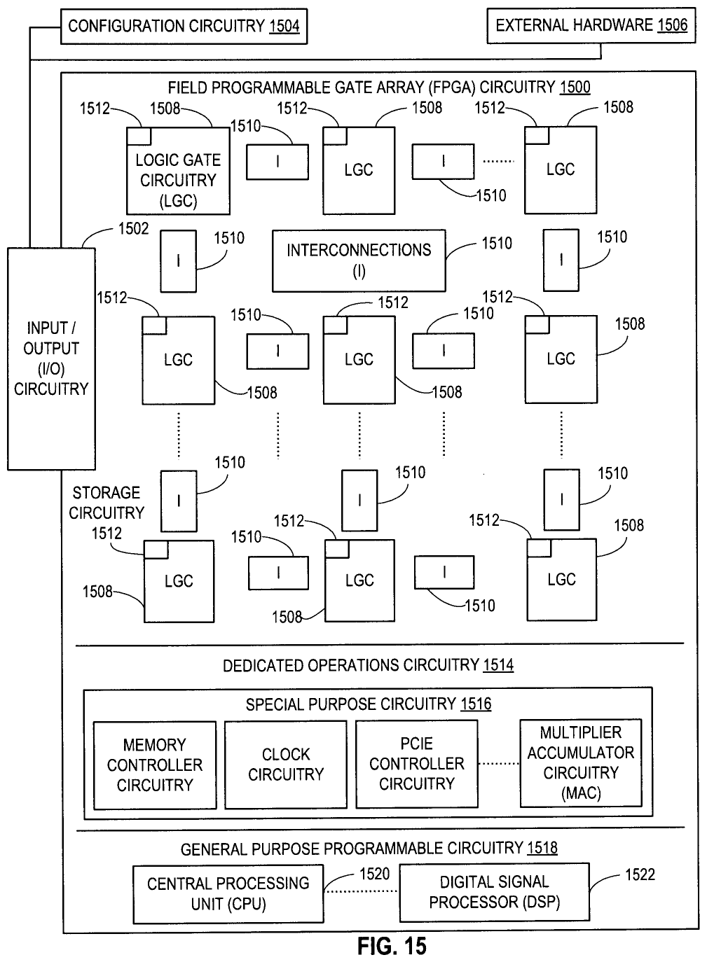

In some examples, the power predictor circuitry 106 includes means for communicating. For example, the means for communicating may be implemented by interface circuitry 202. In some examples, the interface circuitry 202 may be instantiated by processor circuitry such as the example processor circuitry 1312 of FIG. 13. For instance, the interface circuitry 202 may be instantiated by the example microprocessor 1400 of FIG. 14 executing machine executable instructions such as those implemented by at least blocks 902, 904 of FIG. 9. In some examples, the interface circuitry 202 may be instantiated by hardware logic circuitry, which may be implemented by an ASIC, XPU, or the FPGA circuitry 1500 of FIG. 15 structured to perform operations corresponding to the machine readable instructions. Additionally or alternatively, the interface circuitry 202 may be instantiated by any other combination of hardware, software, and/or firmware. For example, the interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

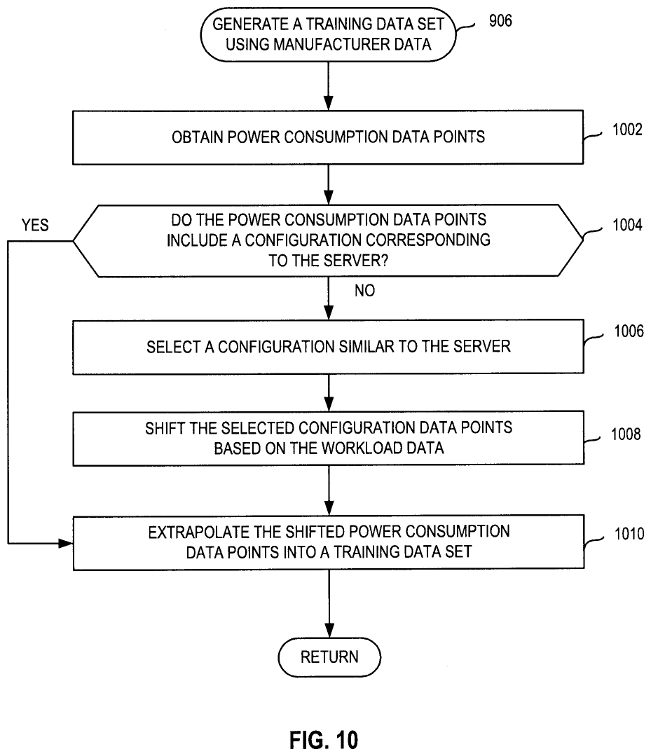

In some examples, the power predictor circuitry 106 includes means for generating a training data set. For example, the means for generating a training data set may be implemented by baseline model circuitry 204. In some examples, the baseline model circuitry 204 may be instantiated by processor circuitry such as the example processor circuitry 1312 of FIG. 13. For instance, the baseline model circuitry 204 may be instantiated by the example microprocessor 1400 of FIG. 14 executing machine executable instructions such as those implemented by at least blocks 906, 1002-1010 of FIGS. 9 and 10. In some examples, the baseline model circuitry 204 may be instantiated by hardware logic circuitry, which may be implemented by an ASIC, XPU, or the FPGA circuitry 1500 of FIG. 15 structured to perform operations corresponding to the machine readable instructions. Additionally or alternatively, the baseline model circuitry 204 may be instantiated by any other combination of hardware, software, and/or firmware. For example, the baseline model circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the power predictor circuitry 106 includes means for modifying the training data set. For example, the means for modifying the training data set may be implemented by workload model circuitry 206. In some examples, the workload model circuitry 206 may be instantiated by processor circuitry such as the example processor circuitry 1312 of FIG. 13. For instance, the workload model circuitry 206 may be instantiated by the example microprocessor 1400 of FIG. 14 executing machine executable instructions such as those implemented by at least blocks 908 of FIG. 9. In some examples, the workload model circuitry 206 may be instantiated by hardware logic circuitry, which may be implemented by an ASIC, XPU, or the FPGA circuitry 1500 of FIG. 15 structured to perform operations corresponding to the machine readable instructions. Additionally or alternatively, the workload model circuitry 206 may be instantiated by any other combination of hardware, software, and/or firmware. For example, the workload model circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the power predictor circuitry 106 includes means for dividing a range of workloads. For example, the means for dividing a range of workloads may be implemented by sub-range determiner circuitry 210. In some examples, the sub-range determiner circuitry 210 may be instantiated by processor circuitry such as the example processor circuitry 1312 of FIG. 13. For instance, the sub-range determiner circuitry 210 may be instantiated by the example microprocessor 1400 of FIG. 14 executing machine executable instructions such as those implemented by at least blocks 910 of FIG. 9. In some examples, the sub-range determiner circuitry 210 may be instantiated by hardware logic circuitry, which may be implemented by an ASIC, XPU, or the FPGA circuitry 1500 of FIG. 15 structured to perform operations corresponding to the machine readable instructions. Additionally or alternatively, the sub-range determiner circuitry 210 may be instantiated by any other combination of hardware, software, and/or firmware. For example, the sub-range determiner circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the power predictor circuitry 106 includes means for training a model. For example, the means for training a model may be implemented by model trainer circuitry 212. In some examples, the model trainer circuitry 212 may be instantiated by processor circuitry such as the example processor circuitry 1312 of FIG. 13. For instance, the model trainer circuitry 212 may be instantiated by the example microprocessor 1400 of FIG. 14 executing machine executable instructions such as those implemented by at least blocks 914 of FIG. 9. In some examples, the model trainer circuitry 212 may be instantiated by hardware logic circuitry, which may be implemented by an ASIC, XPU, or the FPGA circuitry 1500 of FIG. 15 structured to perform operations corresponding to the machine readable instructions. Additionally or alternatively, the model trainer circuitry 212 may be instantiated by any other combination of hardware, software, and/or firmware. For example, the model trainer circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

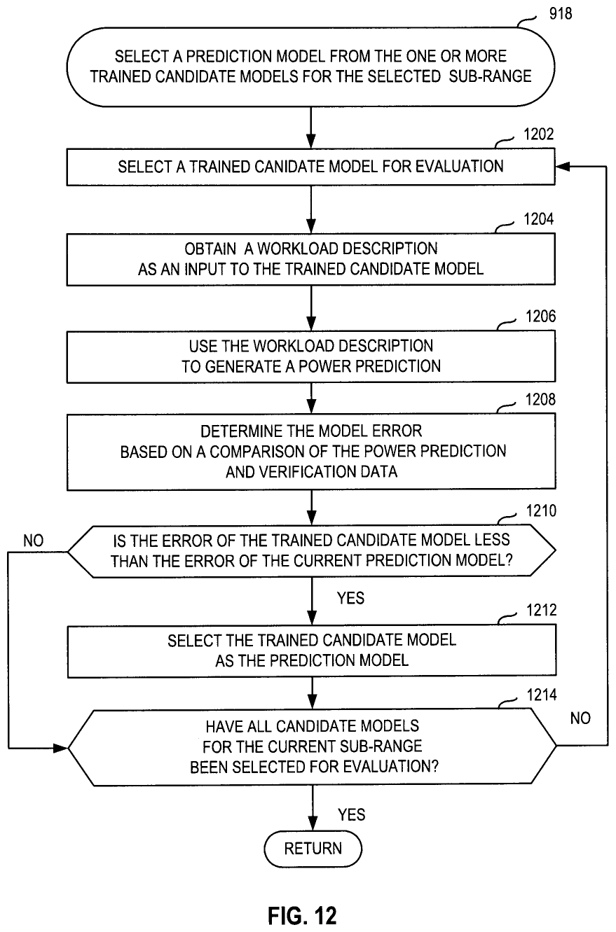

In some examples, the power predictor circuitry 106 includes means for executing a model. For example, the means for executing a model may be implemented by model executor circuitry 214. In some examples, the model executor circuitry 214 may be instantiated by processor circuitry such as the example processor circuitry 1312 of FIG. 13. For instance, the model executor circuitry 214 may be instantiated by the example microprocessor 1400 of FIG. 14 executing machine executable instructions such as those implemented by at least blocks 1202-1206 of FIG. 12. In some examples, the model executor circuitry 214 may be instantiated by hardware logic circuitry, which may be implemented by an ASIC, XPU, or the FPGA circuitry 1500 of FIG. 15 structured to perform operations corresponding to the machine readable instructions. Additionally or alternatively, the model executor circuitry 214 may be instantiated by any other combination of hardware, software, and/or firmware. For example, the model executor circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the power predictor circuitry 106 includes means for selecting a prediction model. For example, the means for selecting a prediction model may be implemented by prediction selector circuitry 216. In some examples, the prediction selector circuitry 216 may be instantiated by processor circuitry such as the example processor circuitry 1312 of FIG. 13. For instance, the prediction selector circuitry 216 may be instantiated by the example microprocessor 1400 of FIG. 14 executing machine executable instructions such as those implemented by at least blocks 1208-1214 of FIG. 12. In some examples, the prediction selector circuitry 216 may be instantiated by hardware logic circuitry, which may be implemented by an ASIC, XPU, or the FPGA circuitry 1500 of FIG. 15 structured to perform operations corresponding to the machine readable instructions. Additionally or alternatively, the prediction selector circuitry 216 may be instantiated by any other combination of hardware, software, and/or firmware. For example, the prediction selector circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

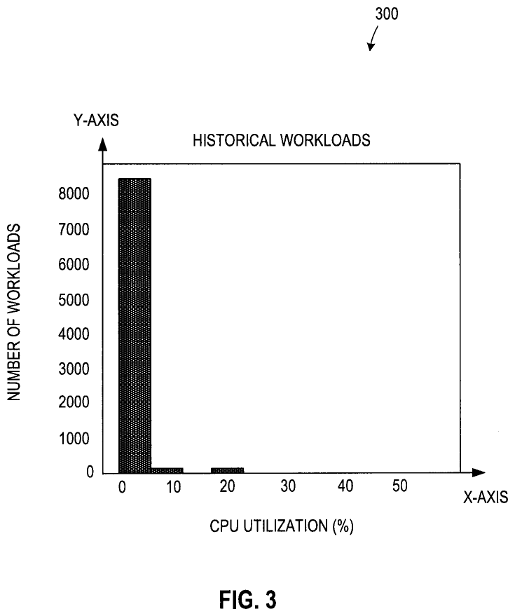

FIG. 3 is a graph 300 that shows historical workloads of a server (e.g., the server 104A of FIG. 1) from the data center 102 of FIG. 1. The y-axis (e.g., the vertical axis) of the example historical workloads graph 300 shows the number of workloads that were executed by the server 104A over thirty days of operation. The x-axis (e.g., the horizontal axis) of the example graph 300 shows CPU utilization as a percentage. In some examples, CPU utilization is calculated as the average percentage of time within a window in which logical threads corresponding to a workload are non-idle. For example, suppose a set of two logical threads in a CPU in the server 104A correspond to a workload. Within the set, suppose a first logical thread is non-idle for 10 seconds out of a 20-second window (e.g., a 50% CPU utilization) and that a second logical thread is non-idle for 0 seconds of the 20-second window (e.g., a 100% CPU utilization). In such an example, the CPU utilization of the workload is an average of the CPU utilization of the logical threads that correspond to the workload (e.g., 75% CPU utilization). In other examples, a different length of time is used as a window to determine CPU utilization. In examples disclosed herein, CPU utilization is one metric used to characterize workloads and sub-ranges of workload.

FIG. 3 illustrates how historical workloads can be highly localized. For example, of 8,728 total workloads represented in the example graph 300, over 8,000 workloads were in a first sub-range of workloads that incur CPU utilization between 0% and 5%, while less than 500 workloads were in a second sub-range of workloads that incur CPU utilization between 5% and 50%. As a result, historical workload data is unavailable for the second sub-ranges of workloads. For example, if the example central facility 110 wanted to determine power prediction estimates when the server 104A executes workloads between 25% and 50% CPU utilization, the graph 300 indicates that no such historical data is available to use as a basis for the prediction model. Furthermore, running sample workloads on the server 104A across wider sub-ranges of workloads may be impractical because compute devices in the example data center 102 are actively being used for business operations. Advantageously, the example power predictor circuitry 106 generates accurate power prediction models across the entire range of workloads while the server 104A continues to perform its primary function (i.e., execute workloads in a particular sub-range).

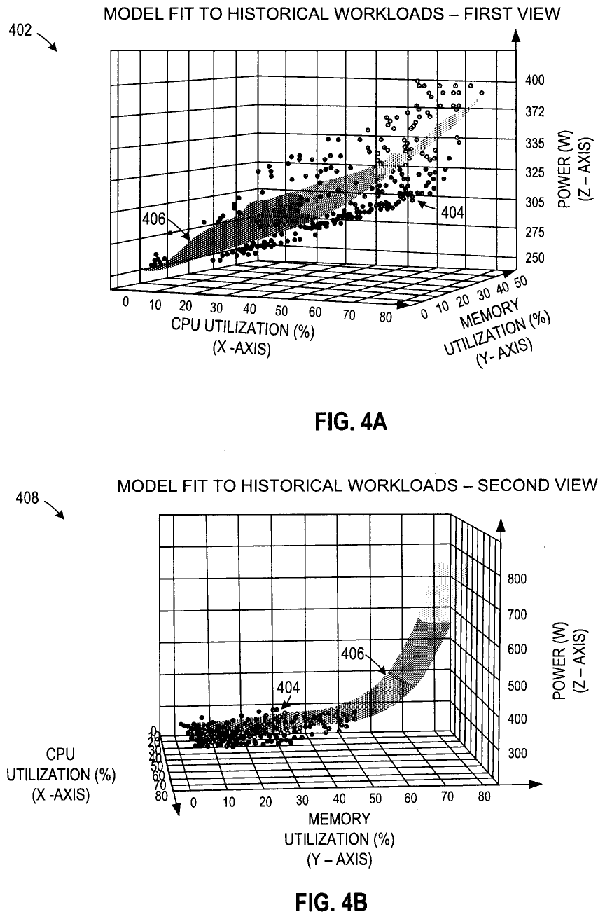

FIGS. 4A and 4B are graphs illustrating models based exclusively on historical workloads. FIG. 4A includes an example graph 402 of a model fit to historical workloads in a first view, which includes example data points 404 and an example three-dimensional surface 406. FIG. 4B includes an example graph 408 of the model fit to the historical workloads in a second view, which includes the data points 404 and example surface 406.

The example graph 402 includes data points 404 which correspond to workloads that were previously executed by a server in the example data center 102. The z-axis of the graph 402 displays power consumption, in Watts (W), of a given workload. The x and y axes of the graph 402 represent two characterizations of historically executed workloads. Specifically, the x-axis represents CPU utilization as a percentage and the y-axis represents memory utilization as a percentage. In some examples, memory utilization is calculated as a ratio of the amount of memory consumed on the compute device (e.g., the server 104A) to run virtual machines (VMs) corresponding to a given workload to the total amount of available memory. Consumed memory that corresponds to a given workload may include, but is not limited to, memory consumed by a VM kernel, virtual service platforms and their respective management agents, etc. For example, if the server 104A has 32 gigabytes (GB) of RAM available, of which 16 GB of RAM is consumed by a given workload, the workload would have a memory utilization of 50%. While the three-dimensional data points 404 are represented visually in FIGS. 4A, 4B, other examples may represent the same information in the following textual format:
<power: z W; workload: x % CPU util., y % memory util.>.
   In some examples, the amount of memory consumed on the compute device (e.g., the server 104A) to run virtual machines (VMs) corresponding to a given workload is referred to as used memory.

The workloads of FIG. 3 were characterized in one dimension, for simplicity. However, examples described herein characterize workloads in two dimensions—namely, CPU utilization and memory utilization. Examples disclosed herein describe workloads in the foregoing manner because empirical analysis shows that CPU utilization and memory utilization are generally the two most relevant factors to power consumption. In other examples, the power predictor circuitry 106 uses any number of dimensions to characterize a workload. Additional dimensions to characterize a workload may include, but are not limited to, network speed, divisions of memory into disks and cache, active memory, etc. As used herein, active memory refers to the portion of used memory that 1) corresponds to a specific workload and 2) has been actively utilized in an input or output (I/O) operation in a given time frame. In some examples, the power predictor circuitry 106 uses multiple dimensions (i.e., multiple variables) to describe any one factor (e.g., CPU). For example, a CPU utilization may be characterized using sub-utilizations such as core utilizations for multi-core CPUs, cache hit rates, cache utilization, etc.

Within the graph 402, the example surface 406 is a model that may be used to predict power consumption. Specifically, the surface 406 is a three-dimensional surface equation that best fits the example data points 404. By inserting a two-dimensional description of a hypothetical workload into the equation that defines the surface 406, a corresponding power consumption estimate can be obtained.

Like the example graph 402, the example graph 408 also shows the data points 404 and the surface 406. However, while the example graph 402 illustrates a relatively small sub-range of workloads, the example graph 408 illustrates a larger sub-range. This difference is visible in a comparison of axes between graphs. For example, the y-axis of graph 402 shows memory utilization spanning from 0% to 50%, and the same metric spans from 0% to 80% in the y-axis of graph 408.

FIGS. 4A and 4B shows that, while models based exclusively on historical data (such as the example surface 406) can be relatively accurate for a small sub-range of workloads, the models do not retain their accuracy across the entire range of possible workloads that a server can execute. This decrease in accuracy is due to the historical data being highly localized, resulting in little to no historical data in some sub-ranges (e.g., between 50-80% memory utilization) available to tune the model. Advantageously, the example baseline model circuitry 204 populates the example training data set 208 using manufacturing data. As a result, the example training data set 208 is not highly localized and the corresponding models are accurate across the entire range of possible workloads.

FIG. 5 is a graph illustrating power consumption data obtained from a manufacturer. The example graph 500 includes example configurations 504, 506, 508, 510, 512. The example graph 500 is an example of manufacturing data obtained by the baseline model circuitry 204. In particular, the example graph 500 shows a product data set of expected power consumption data for the Dell® PowerEdge R650 Rack Server. In other examples, the baseline model circuitry 204 obtains a product data set corresponding to a different compute device product in the data center 102. The example graph 500 shows data published by Dell® in a technical data sheet for the PowerEdge R650 Rack Server. In other examples, the baseline model circuitry 204 obtains manufacturing data from another source.

In some examples, a manufacturer will sell multiple hardware configurations of a single product. For example, the configuration 504 represents a product with a first amount of Random Access Memory (RAM) and a first amount of Read Only Memory (ROM), the configuration 506 represents the same product with a second amount of RAM and a second amount of ROM, etc. In the illustrative example of FIG. 5, the baseline model circuitry 204 obtained manufacturing data for five different configurations of the Dell® PowerEdge R650 Rack Server. In other examples, the baseline model circuitry 204 obtains a different number of configurations.

In the example graph 500, the ten data points spanning across 0% to 100 CPU % illustrate how manufacturing data can span across a greater sub-range than the available historical workload data, which is highly localized (as shown in FIG. 3). Advantageously, by using the baseline model circuitry 204 to add data in sub-ranges with little to no historical workload data, the power predictor circuitry 106 avoids producing the example surface 406 that in a way that includes unreasonable power consumption estimates in the sub-ranges.

Although rare, in some examples, the baseline model circuitry 204 is unable to find manufacturing data that spans across a greater sub-range than the available historical workload data. In such examples, the data center power manager 118 may modify the operating instructions 120 to execute test workloads in sub-ranges other than the historical workload data and record the corresponding power consumption metrics. The example workload model circuitry 206 then combines the resulting test workload data points and historical workload data points to form the training data set 208. In such examples, the data center power manager 118 executes specific test workloads on the server 104A such that distribution of data in the example training data set 208 satisfies a threshold (e.g., the data spans across a threshold number of standard deviations from a mean).

FIG. 6 is a graph illustrating the operations of the baseline model circuitry of FIG. 2. The example graph 600 includes the example configuration 504, example data points 602, and an example baseline surface 604.

In the illustrated example of FIG. 6, the graph 600 shows operations the baseline model circuitry 204 performs when the power prediction request is for models corresponding to the server 204A. Furthermore, the server 204A is implemented with the configuration 504 in the illustrative example of FIG. 6.

While the manufacturing data of FIG. 5 may contain data that spans a larger sub-range of workloads than the historical workload data of FIG. 3, the manufacturing data may not cover the entire range of possible workloads executable by the example server 204A. Furthermore, the quantity of publicly available manufacturer data may be limited. In the illustrated example of FIG. 5, for instance, only ten data points are available for use when generating a given set of prediction models (as any given compute device in the data center 102 would correspond to only one of the configurations 504, 506, 508, 510, 512). Therefore, after obtaining the configuration 504 for the server 204A, the example baseline model circuitry 204 extrapolates the manufacturing data so that the data points 602 span across the entire range of possible workloads, and so that additional data is available for use in training the example prediction models 114A.

The example graph 600 shows the baseline model circuitry 204 extrapolated the example configuration 504, which contained one dimensional workload data (i.e., CPU utilization), into the example baseline surface 604, which contains two-dimensional workload data (i.e., CPU utilization and memory utilization). In the example graph 600, the baseline surface 604 is a plane that may be defined by a low-order polynomial equation. In other examples, the low-order polynomial equation that defines the baseline surface 604 does not form a plane. To generate the data points 602, the example baseline model circuitry 204 uses inputs representative of two-dimensional workload data to solve the low-order polynomial equation and output a corresponding power consumption estimate. While FIG. 6 only illustrates the data points 602 from the example configuration 504 and on the periphery of the baseline surface 604 for simplicity, in practice, the baseline model circuitry 204 may generate any number of additional data points anywhere on the baseline surface 604.

In some examples, the baseline model circuitry 204 may determine that none of the obtained configurations 504, 506, 508, 510, 512 are similar enough to the server 104A to perform a direct extrapolation (as shown in FIG. 6). In such examples, the baseline model circuitry 204 may select a configuration 504 and shift the data points in the configuration based on historical workload data. The example baseline model circuitry 204 then extrapolates the shifted version of the configuration to form the first version of the training data set 208. Shifting configuration data points is further discussed in connection with FIG. 10.

The example data points 602 collectively form the first version of the training data set 208. By obtaining and extrapolating manufacturer data to form the data points 602, the example baseline model circuitry 204 makes sure additional data is available for use in training the example prediction models 114A, and that said data points span across the entire range of possible workloads.

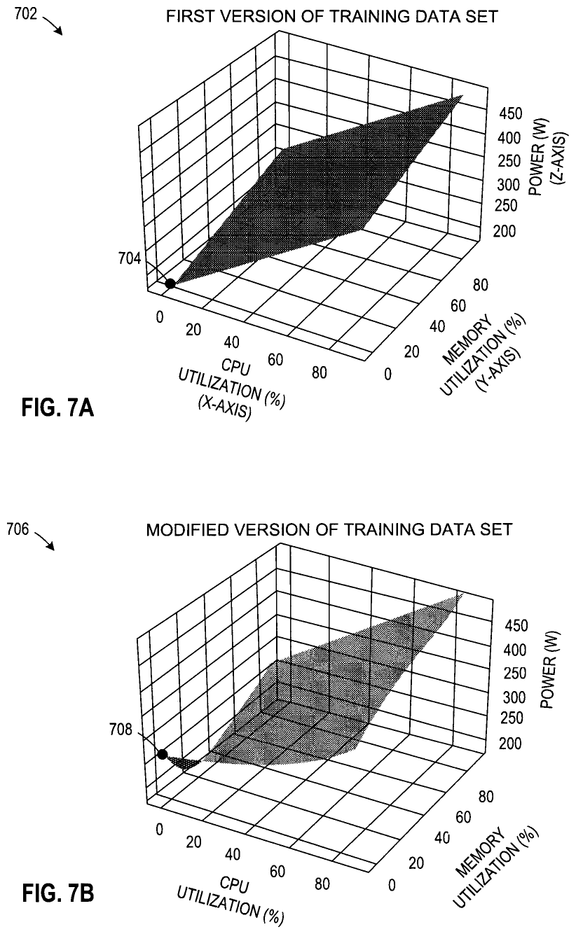

FIGS. 7A and 7B are graphs illustrating the operations of the workload model circuitry 206 of FIG. 2. FIG. 7 includes an example graph 702, which includes example data point 704, and an example graph 706, which includes example data point 708.

The example graph 702 is a visual representation of the first version of the training data set 208. Like FIG. 6, the example graph 702 shows a plane in which, prior to modifications by the workload model circuitry 206, all data points 602 (FIG. 6) in the example training data set 208 lie. In the illustrative example of FIG. 7, the data point 704 is one data point (e.g., a CPU utilization value, a memory utilization value, and a corresponding power consumption estimate) in the plurality of data points 602.

The example graph 706 is a visual representation of the modified version of the training data set 208. The example workload model circuitry 206 modifies the initial version of the training data set by replacing ones of the data points 602 with corresponding historical workload datapoints (e.g., data points that were previously recorded on the server 204A). For example, suppose the data point 704 is composed of:
<power: 100 W; workload: 0% CPU util., 0% memory util.>.
   In such examples, the data point 704 conveys that a manufacturer published data stating the Dell® PowerEdge R650 Rack Server consumes 100 W of power at idle. However, when the server 104A operates in the data center 102, the central facility 110 recorded the server 104A consuming 215 W of power at idle. As a result, the example workload model circuitry 206 modifies the training data set 208 by replacing the data point 704 with the data point 708:
<power: 215 W; workload: 0% CPU util., 0% memory util.>.
   The example workload model circuitry 206 may additionally replace any number of the data points 602 when modifying the training data set 208.

Although the server 104A is an example implementation of the Dell® PowerEdge R650 Rack Server, and the example training data points 704, 708 describe the same workload, the manufacturer power consumption value (100 W) in the data point 704 is different from the historical workload power consumption value (215 W). This difference in power consumption metrics can occur for any number of reasons, including but not limited to temperature, age of the compute device, fan speed, CPU and memory throttling, etc. To account for these device specific differences, the example workload model circuitry 206 modifies the training data set 208 to include recorded power consumption metrics from the server 204A and their corresponding workload descriptions. As a result, the example power predictor circuitry 106 can generate prediction models 114A that are specifically tuned to predict the power consumption of the server 104A.

While an example manner of implementing the power predictor circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 202, the example baseline model circuitry 204, the example workload model circuitry 206, the example sub-range determiner circuitry 210, the example model trainer circuitry 212, the example model executor circuitry 214, and the example prediction selector circuitry 216, and/or, more generally, the example power predictor circuitry 106 of FIGS. 1 and 2, may be implemented by hardware alone or by hardware in combination with software and/or firmware. Thus, for example, any of the example interface circuitry 202, the example baseline model circuitry 204, the example workload model circuitry 206, the example sub-range determiner circuitry 210, the example model trainer circuitry 212, the example model executor circuitry 214, and the example prediction selector circuitry 216, and/or, more generally, the example power predictor circuitry 106 of FIGS. 1 and 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example interface circuitry 202 of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the central facility 110 of FIG. 1 and the power predictor circuitry 106 of FIG. 2, are shown in FIGS. 8-12. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 8-12, many other methods of implementing the example central facility 110 of FIG. 1 and the power predictor circuitry 106 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 8-12 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to implement the operations of the example data center power manager 118. The machine readable instructions and/or the operations 800 of FIG. 8 begin when the example data center power manager 118 generates a power prediction request 112 (FIG. 1) corresponding to a server. (Block 802). In examples disclosed herein, the power prediction request 112 corresponds to the server 104A in the data center 102 of FIG. 1. In other examples, the power prediction request 112 corresponds to another computing device in any location.

The example data center power manager 118 provides the power prediction request 112 to the power predictor circuitry 106 (FIG. 1). (Block 804). The power prediction request 112 may be sent by the central facility 110 using over any suitable communication protocol. In some examples, the central facility 110 provides the power prediction request 112 via the network 108 (FIG. 1).

The example data center power manager 118 obtains one or more prediction models 114A (FIG. 1) corresponding to the server. (Block 806). The one or more prediction models are generated by the power predictor circuitry 106 in response to the power prediction request 112. The generation of the prediction models 114A is discussed further in connection with FIGS. 9-11.

The example data center power manager 118 selects a prediction model based on a desired sub-range. (Block 808). For example, if the example data center power manager 118 requires a power consumption estimate for the server 104A for a workload that operates at 25% CPU utilization and 75% memory utilization, the example data center power manager 118 would select the model with the sub-range that includes 25% CPU utilization and 75% memory utilization. Because the example power predictor circuitry 106 forms the prediction models 114A such that the corresponding sub-ranges are mutually exclusive, only one of the models in the prediction models 114A will be tuned to estimate the desired workload and be selected at block 808.

The example data center power manager 118 executes the selected prediction model to obtain a power consumption estimate. (Block 810). For example, to execute the model, the data center power manager 118 uses the desired workload description (e.g., 25% CPU utilization and 75% memory utilization) as inputs to perform operations as defined by the selected prediction model. Model execution is discussed further in connection with FIG. 12 below.

The example data center power manager 118 generates or modifies operating instructions 120 based on the power consumption estimate. (Block 812). For example, the data center power manager 118 may cause the server 104A to execute additional and/or different types of workloads based on the power consumption estimate. Additionally or alternatively, the example data center power manager 118 generates sustainability information based on the power consumption estimate. (Block 814). The example machine readable instructions and/or operations 800 end after one or both of blocks 812, 814.

FIG. 9 is a flowchart representative of example machine readable instructions and/or example operations that may be executed by example processor circuitry to implement the power predictor circuitry 106 of FIG. 1. The machine readable instructions and/or the operations 900 of FIG. 9 begin when the example interface circuitry 202 (FIG. 2) obtains a power prediction request 112 (FIG. 1) corresponding to a server. (Block 902). In the example flowchart of FIG. 9, the power prediction request 112 obtained in block 902 is provided by the example data center power manager 118 (FIG. 1) at block 804 and corresponds to the server 104A.

The example workload model circuitry 206 (FIG. 2) causes the interface circuitry 202 to obtain workload data from the server 104A (FIG. 1). (Block 904). In the example flowchart of FIG. 9, the obtained data is historical workload data (e.g., the data points 404 of FIG. 4) that includes a two-dimensional characterization of one or more workloads previously executed by the server 104A and power consumption metrics that were recorded on the server 104A during the execution of the one or more workloads.

The example baseline model circuitry 204 (FIG. 2) generates a training data set 208 using manufacturer data. (Block 906). Specifically, the baseline model circuitry 204 generates an initial version of the training data set 208 that is further modified by the workload model circuitry 206. Example instructions to implement block 906 are discussed below in connection with FIG. 10.

The example workload model circuitry 206 modifies the training data set 208 using the historical workload data. (Block 908). The modifications include replacing ones of the manufacturer data points in the training data set 208 with historical workload data that have the same or similar workload characterizations.

The example sub-range determiner circuitry 210 divides the modified version of the training data set 208 into sub-ranges. (Block 910). For example, the sub-range determiner circuitry 210 may divide the two-dimensional workload range into a first sub-range (0%-50% CPU utilization; 0%-50% memory utilization), a second sub-range (0%-50% CPU utilization; 50%-100% memory utilization), a third sub-range (50%-100% CPU utilization; 0%-50% memory utilization), and a fourth sub-range (50%-100% CPU utilization; 50%-100% memory utilization). In other examples, the sub-range determiner circuitry 210 divides the training data set 208 into a different number and/or different sizes of sub-ranges.

In some examples, the size of the sub-ranges is nonuniform. For instance, the sub-range determiner circuitry 210 may divide a first portion of possible workloads that is more dense with historical workload data into a greater number of sub-ranges than a second portion of possible workloads that is less dense with historical workload data. In doing so, a given sub-range from the first portion of possible workloads will be tuned to predict a smaller subset of workloads, and therefore may be more accurate, than a given sub-range form the second portion of possible workloads. The example sub-range determiner circuitry 210 may additionally or alternatively divide the range such that each sub-range includes a minimum number of data points. The example sub-range determiner circuitry 210 may determine the number and/or sizes of sub-ranges based on any number of factors, including but not limited to an amount of available resources (e.g., compute resources, memory resources, storage resources, etc.), a timing requirement, pre-determined instructions stored in memory, or instructions embedded in the power prediction request 112 via the data center power manager 118.

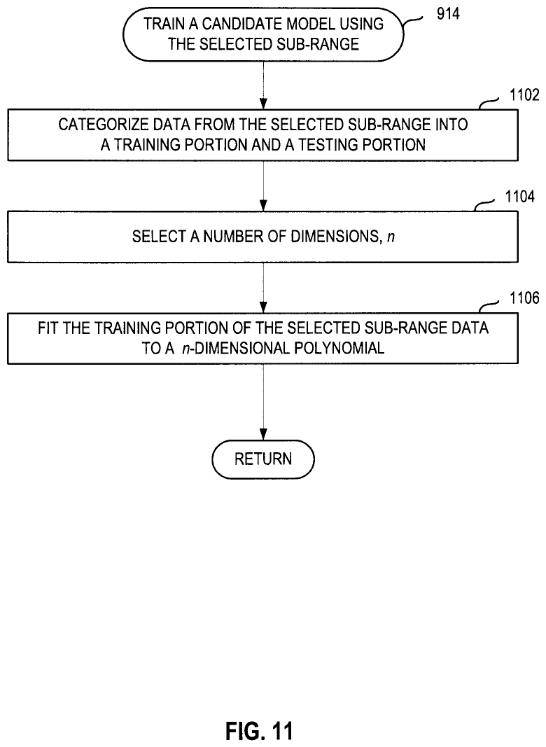

The example model trainer circuitry 212 (FIG. 2) selects a sub-range of data from the training data set 208. (Block 912). The example model trainer circuitry 212 then uses the selected sub-range to train a candidate model. (Block 914). The candidate model may be any type of model that can produce a power consumption estimate based on a workload characterization. Types of candidate models include, but are not limited to, CNNs, SVMs, random forest classifiers, n-dimensional polynomial regression, multi-variable power equations, etc. To train a candidate model, the example model trainer circuitry 212 may use the data in the selected sub-range to adjust one or more parameters that control the output of the model. The example model trainer circuitry 212 may iteratively adjust the one or more parameters to minimize a difference between the output of the candidate model and an expected output. An example of model training using n-dimensional polynomial regression is described below in connection with FIG. 11.

The example model trainer circuitry 212 determines whether to train another candidate model for the selected sub-range. (Block 916). The example model trainer circuitry 212 may train any number of additional candidate models for the selected sub-range. The example model trainer circuitry 212 may determine whether to train another candidate model based on any number of factors, including but not limited to an amount of available compute resources, a timing requirement, pre-determined instructions stored in memory, or instructions embedded in the power prediction request 112 via the data center power manager 118. If the example model trainer circuitry 212 determines another candidate model should be trained (Block 916: Yes), control returns to block 914. Alternatively, if the example model trainer circuitry 212 determines no additional candidate model should be trained (Block 916: No), control advances to block 918.

The example prediction selector circuitry 216 (FIG. 2) selects a prediction model from the one or more trained candidate models for the selected sub-range. (Block 918). In some examples, the selected model is referred to as a prediction model. Example instructions that may be used to implement block 918 are discussed below in connection with FIG. 10.

The example model trainer circuitry 212 determines whether all sub-ranges have been considered. (Block 920). If all sub-ranges have not been considered (Block 920: No), control returns to block 912, where the model trainer circuitry 212 selects another sub-range. If all sub-ranges have been considered (Block 920: Yes), control proceeds to block 922.

The example model trainer circuitry 212 provides the prediction models to the data center power manager 118 via the interface circuitry 202. (Block 922). The example machine readable instructions and/or operations 900 end.

FIG. 10 is a flowchart representative of example machine readable instructions and/or example operations that may be executed by example processor circuitry to implement the baseline model circuitry 204 of FIG. 2. Specifically, the flowchart of FIG. 10 illustrates how the example machine readable instructions and/or operations 900 may be used to implement block 906 of FIG. 9.

Execution of block 906 begins when the example baseline model circuitry 204 causes the interface circuitry 202 (FIG. 2) to obtain power consumption data points corresponding to the server 104A. (Block 1002). In some examples, a product data set for the same compute device product as the server 104A exist in the baseline database 105 at the time block 1002 is executed. In such examples, the power consumption data points of block 1002 refer to a copy of the existing product set. For example, suppose both the server 104A and the server 104B are Dell® PowerEdge R650 Rack Servers. Suppose the power predictor circuitry 106 also receives a first prediction request 112 corresponding to the server 104A and a second prediction request 112 corresponding to server 104B. In such examples, the power consumption data points in the second iteration of block 1002 (i.e., when generating prediction models 114B for the server 104B) refer to the existing Dell® PowerEdge R650 Rack Servers product data set in the baseline database 205.

In other examples, a corresponding product data set does not exist in the baseline database 205. For example, if the server 104A was the first Dell® PowerEdge R650 Rack Server processed by the example power predictor circuitry 106, then a corresponding product data set did not exist in the baseline database 205 during the first iteration of block 1002 (i.e., when generating prediction models 114A for the server 104A). In such other examples, the power consumption data points refer to manufacturer data obtained by the interface circuitry 202 via the network 108. The power consumption data points may come from any source, including but not limited to a data sheet, a white paper, a manufacturer website, etc. The power consumption data points may correspond to multiple configurations of the same compute device product, as shown in FIG. 5.

The example baseline model circuitry 204 determines whether the power consumption data points include a resource configuration corresponding to the server 104A. (Block 1004). The example baseline model circuitry 204 may perform the determination of block 1004 by comparing the resource configuration information (e.g., an amount of RAM, an amount of ROM, etc.) of the server to the configuration information of the obtained power consumption data points. In some examples, a configuration of the obtained power consumption data points correspond to the configuration of the server 104A (FIG. 1) if both configurations contain the same information. In other examples, a configuration of the obtained power consumption data points correspond to the configuration of the server 104A if the configurations include a threshold amount of the same or similar information.

If the example baseline model circuitry 204 determines the power consumption data points do include a configuration corresponding to the server 104A (Block 1004: Yes), control advances to block 1010. If the example baseline model circuitry 204 determines the power consumption data points do not include a configuration corresponding to the server 104A (Block 1004: No), the baseline model circuitry 204 selects a configuration from the power consumption data points that is similar to the server 104A. (Block 1006). In some examples, the baseline model circuitry 204 may determine a similarity by quantifying a difference in configuration information. For example, if the server 104A has 32 GB of RAM and 1 terabyte (TB) of ROM, a first configuration from the obtained power consumption data points with 40 GB of RAM and 1.25 TB of ROM may be considered more similar than a second configuration with 8 GB of RAM and 0.25 TB of ROM.

The example baseline model circuitry 204 shifts the selected configuration data based on the workload data obtained in block 904. (Block 1008). To shift a given data point in the selected configuration data, the example baseline model circuitry 204 selects a historical workload data point that has a matching or similar workload. In a first example, suppose a data point in the selected configuration data is given by:
<power: 300 W; workload: 50% CPU util., 50% memory util.>.
   Further, suppose the baseline model circuitry 204 additionally determines the workload data includes a recorded power consumption metric for the server 104A of:
<power: 305 W; workload: 50% CPU util., 50% memory util.>.
   In such a first example, the baseline model circuitry 204 will shift the configuration data point to match the historical workload data:
<power: 305 W; workload: 50% CPU util., 50% memory util.>.

In a second example, the baseline model circuitry 204 does not find a recorded power consumption metric of the server 104A executing a workload that is exactly 50% CPU utilization and 50% memory utilization. In such other example, the baseline model circuitry 204 selects a historical workload data point with a similar workload. Any suitable method may be used to quantify the similarity between two-dimensional workload descriptions. Example techniques to quantify a similarity between two-dimensional data include but are not limited to a Euclidean distance measurement, a k-nearest neighbors algorithm, etc.

Once a similar historical workload data point is selected, the example baseline model circuitry 204 may adjust the data point in the selected configuration data by an amount that is proportional to the quantified similarity (e.g., the Euclidean distance) between the selected configuration data point and the historical workload data. For instance, suppose the second example includes the same configuration data point from the manufacturer:
<power 300 W; workload: 50% CPU util., 50% memory util.>.
   Suppose the second example further includes a different selected data point from the historical workload data:
<power 350 W; workload: 60% CPU util., 60% memory util.>.
   In such a second example, the baseline model circuitry 204 adjusts the configuration data point to a proportional power consumption metric such as:
<power 325 W; workload: 50% CPU util., 50% memory util.>.
   In examples where the power consumption data points do not include a configuration corresponding to the server (Block 1004: No), the example baseline model circuitry 204 may use the foregoing techniques to shift each data point in the configuration selected at block 1006.

The example baseline model circuitry 204 extrapolates the shifted power consumption data points to form a first version of the training data set 208. (Block 1010). Extrapolation may include 1) defining a low dimensional polynomial surface to characterize the existing data points and 2) adding additional points that lie on the surface, as described above in connection with FIG. 6.

In examples where the obtained manufacturer data only includes one dimensional workload descriptions (as opposed to the two-dimensional workload description in the example flowchart of FIG. 10), extrapolation additionally includes the introduction of one of a) CPU utilization metrics, or b) memory utilization metrics, so that the workload data used for training is two-dimensional. In such examples, the baseline model circuitry 204 may introduce a workload metric as a pre-determined value based on the value of the other dimensions in the data point (e.g., power and one of CPU utilization or memory utilization). In some examples, the pre-determined values are determined by the data center power manager 118 via the power prediction request 112. The example machine readable instructions and/or operations 900 return to block 908 of FIG. 9 after block 1010 and the example instructions and/or operations of FIG. 10 end.

FIG. 11 is a flowchart representative of example machine readable instructions and/or example operations that may be executed by example processor circuitry to implement the model trainer circuitry 212 of FIG. 2. Specifically, FIG. 11 describes how the example model trainer circuitry 212 implements block 914 of FIG. 9 to train candidate models using n-dimensional polynomial regression.

Execution of block 914 begins when the example model trainer circuitry 212 (FIG. 2) categorizes data from the training data set 208 and in the selected sub-range into one of a training portion and a testing portion. (Block 1102). The example model trainer circuitry 212 trains candidate models using the training portion of the data and reserves the testing portion for model evaluation. Model evaluation is discussed further below in connection with FIG. 12. In some examples, the model trainer circuitry 212 categorizes 70% of the data from the training data set 208 in the selected sub-range as the training portion and categorizes the remaining 30% as the testing portion. In other examples, the model trainer circuitry 212 categorizes different percentages of data into the training portion and the testing portion.

The example model trainer circuitry 212 selects a number of dimensions, n. (Block 1104). The variable n refers to the number of dimensions the candidate model polynomial equation will include. For example, n=1 is a linear equation, n=2 is a quadratic equation, etc. In some examples, the model trainer circuitry 212 selects n=1 in the first iteration of block 1104 and increments the variable n by 1 with each subsequent iteration of the flowchart of FIG. 11. In other examples, the variable n is selected using a different technique. In some examples, the model trainer circuitry 212 iterates from n=1 to n=4 for each selected sub-range.

The example model trainer circuitry 212 fits the training portion of the selected sub-range data to an n-dimensional polynomial. (Block 1106). The example model trainer circuitry 212 may determine the n-dimensional polynomial using least squares method or any other suitable method.

After execution of block 1106, control returns to block 916 of FIG. 9 and the flowchart of FIG. 11 ends. In some example iterations of block 914 (e.g., blocks 1102, 1104, 1106), the model trainer circuitry 212 alternatively trains a different type of candidate model instead of executing the instructions or operations of FIG. 11 to train an n-dimensional polynomial. For example, the model trainer circuitry 212 may train a CNN, a random forest classifier, and/or select a multi-variable power equation using the training portion of the data from block 1102 and any suitable training technique.

FIG. 12 is a flowchart representative of example machine readable instructions and/or example operations that may be executed by example processor circuitry to implement the model executor circuitry 214 and prediction selector circuitry 216 of FIG. 2. Specifically, FIG. 12 describes how the example power predictor circuitry 106 implements block 918 of FIG. 9.

Execution of block 918 begins when the example model executor circuitry 214 (FIG. 2) selects a trained candidate model for evaluation. (Block 1202). The selected trained candidate model is one of a set of trained candidate models developed by the example model trainer circuitry 212 for the sub-range selected in block 912.

The example model executor circuitry 214 obtains a workload description as an input to the trained candidate model. (Block 1204). The workloads description may be any value in the selected sub-range of possible workloads. In some examples, the model executor circuitry 214 obtains multiple workload descriptions throughout the selected sub-range of possible workloads to form multiple inputs.

The example model executor circuitry 214 uses the workload description to generate a power prediction. (Block 1206). Specifically, the model executor circuitry 214 executes the trained candidate model using the workload description as an input. The power prediction is the output of the candidate model, which estimates an amount of power that the server 104A would consume when executing the input workload. In examples with multiple workload description inputs, the model executor circuitry 214 generates a corresponding set of multiple power predictions.

The example prediction selector circuitry 216 (FIG. 2) determines the trained candidate model error based on a comparison of the power prediction and an expected result. (Block 1208). The expected result is a power consumption value associated with the input workload description. For example, the testing portion of the training data set 208, which was separated from the training portion of the training data set 208 at block 1102 of FIG. 11, may be used as expected results. In examples with multiple workload description inputs and multiple power predictions, the example prediction selector circuitry 216 may additionally determine an average model error at block 1208.

The example prediction selector circuitry 216 determines whether the error of the trained candidate model is less than the error of the current prediction model. (Block 1210). In the first iteration of block 1210, there is no current prediction model, so the example machine readable instructions 900 may proceed directly from block 1212 without any determination in block 1210. In subsequent iterations of block 1210 (e.g., during an analysis of another trained candidate model in the selected sub-range), the current prediction model is one of the candidate models selected during a previous iteration.

If the example prediction selector circuitry 216 determines the error of the trained candidate model is less than the error of the current prediction model (Block 1210: Yes), the prediction selector circuitry 216 selects the trained candidate model as the prediction model. (Block 1212). After multiple iterations of blocks 1202-1214 for each trained candidate model in the sub-range, the final selection of prediction model refers to the trained candidate model that is most accurate for that sub-range.

After executing block 1212, or if the example prediction selector circuitry 216 determines the error of the trained candidate model is equal to or greater than the error of the current prediction model (Block 1210: No), the example prediction selector circuitry 216 determines whether all candidate models for the current sub-range have been selected for evaluation. (Block 1214). If all candidate models have not been selected for evaluation (Block 1214: No), control returns to block 1202, where the model executor circuitry 214 selects a new candidate model in the current sub-range for evaluation. The example machine readable instructions and/or operations 900 return to block 920 of FIG. 9 after all candidate models for the current sub-range have been selected for evaluation (Block 1214: Yes). The example instructions and/or operations of FIG. 12 end.

FIG. 13 is a block diagram of an example processor platform 1300 structured to execute and/or instantiate the machine readable instructions and/or the operations of FIGS. 8-12 to implement the data center power manager 118 of FIG. 1 and the power predictor circuitry 106 of FIG. 2. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs, microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the example interface circuitry 202, the example baseline model circuitry 204, the example workload model circuitry 206, the example sub-range determiner circuitry 210, the example model trainer circuitry 212, the example model executor circuitry 214, and the example prediction selector circuitry 216 of FIG. 2.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller. In this example, one or both of the volatile memory 1314, non-volatile memory 1316 may store the training data set 208 of FIG. 2.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1332, which may be implemented by the machine readable instructions of FIGS. 8-12, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1312 of FIG. 13. In this example, the processor circuitry 1312 of FIG. 13 is implemented by a microprocessor 1400. For example, the microprocessor 1400 may be a general purpose microprocessor (e.g., general purpose microprocessor circuitry). The microprocessor 1400 executes some or all of the machine readable instructions of the flowcharts of FIGS. 8-12 to effectively instantiate the data center power manager 118 of FIG. 1 and/or the power predictor circuitry 106 of FIG. 2 as logic circuits to perform the operations corresponding to those machine readable instructions. In some such examples, the data center power manager 118 of FIG. 1 and/or the power predictor circuitry 106 of FIG. 2 is instantiated by the hardware circuits of the microprocessor 1400 in combination with the instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 8-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may be implemented by at least one of an I2C bus, a SPI bus, a PCI bus, or a PCIe bus

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1312 of FIG. 13. In this example, the processor circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 8-12 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowcharts of FIGS. 8-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the software represented by the flowcharts of FIGS. 8-12. As such, the FPGA circuitry 1500 may be structured to effectively instantiate some or all of the machine readable instructions of the flowcharts of FIGS. 8-12 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIGS. 8-12 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may be implemented by external hardware circuitry. For example, the external hardware 1506 may be implemented by the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations that may correspond to at least some of the machine readable instructions of FIGS. 8-12 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 13 and 14 illustrate two example implementations of the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowcharts of FIGS. 8-12 may be executed by one or more of the cores 1402 of FIG. 14, a second portion of the machine readable instructions represented by the flowcharts of FIGS. 8-12 may be executed by the FPGA circuitry 1500 of FIG. 15, and/or a third portion of the machine readable instructions represented by the flowcharts of FIGS. 8-12 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the processor circuitry 1312 of FIG. 13, which may be in one or more packages. For example, the XPU may include a CPU in one package, a DSP in another package, a GPU in yet another package, and an FPGA in still yet another package.

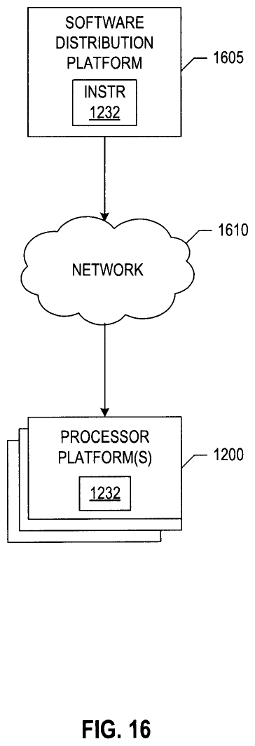

A block diagram illustrating an example software distribution platform 1605 to distribute software such as the example machine readable instructions 1332 of FIG. 13 to hardware devices owned and/or operated by third parties is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions 800, 900 of FIGS. 8-12, as described above. The one or more servers of the example software distribution platform 1605 are in communication with an example network 1610, which may correspond to any one or more of the Internet and/or any of the example networks 108 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions 800, 900 of FIGS. 8-12, may be downloaded to the example processor platform 1300, which is to execute the machine readable instructions 1332 to implement the data center power manager 118 and/or power predictor circuitry 106. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices.

From the foregoing, it will be appreciated that example systems, methods, apparatus, and articles of manufacture have been disclosed that efficiently develop prediction models that accurately estimate the power consumption of a specific compute device. Disclosed systems, methods, apparatus, and articles of manufacture improve the efficiency of using a computing device by generating more accurate power prediction results through obtaining manufacturer data corresponding to a server, extrapolating the data to form a training data set, modifying the training data set with historical workload data, dividing the range of workloads into sub-ranges, training multiple candidate models for each sub-range, and selecting one prediction model for each sub-range from each set of candidate models. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to predict power consumption are disclosed herein. Further examples and combinations thereof include the following.

Example 1 includes an apparatus to predict power consumption in a server, the apparatus comprising interface circuitry to obtain a power prediction request corresponding to the server, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and first logic circuitry to perform one or more first operations corresponding to instructions, and one or more registers to store a first result of the one or more first operations, the instructions in the apparatus, a Field Programmable Gate Array (FPGA), the FPGA including second logic gate circuitry, a plurality of configurable interconnections, and storage circuitry, the second logic gate circuitry and the plurality of the configurable interconnections to perform one or more second operations, the storage circuitry to store a second result of the one or more second operations, or Application Specific Integrated Circuitry (ASIC) including logic gate circuitry to perform one or more third operations, the processor circuitry to perform at least one of the first operations, the second operations, or the third operations to instantiate range determiner circuitry to divide a training data set into a first sub-range of data and a second sub-range of the data, a data point in the training data set representative of resource utilization of a workload and a corresponding power consumption metric of the workload, model trainer circuitry to train first candidate models based on the first sub-range of the data and second candidate models based on the second sub-range of the data, and prediction selector circuitry to select a first prediction model from the first candidate models, and select a second prediction model from the second candidate models, outputs of the first prediction model and the second prediction model to predict the power consumption of the server.

Example 2 includes the apparatus of example 1, wherein the range determiner circuitry is further to divide the training data set into a plurality of sub-ranges, ones of the sub-ranges corresponding to respective numbers of data points greater than or equal to a threshold value.

Example 3 includes the apparatus of example 1, further including baseline model circuitry to generate the training data set, and workload model circuitry to modify the training data set with workload data.

Example 4 includes the apparatus of example 3, wherein to generate the training data set, the baseline model circuitry is to obtain power consumption data points from a manufacturer, the power consumption data points to describe expected power consumption based on a type of the server and a workload description, the workload description to include one or more of central processing unit (CPU) utilization and memory utilization, and extrapolate the power consumption data points to produce additional data points based on the type of the server, the CPU utilization, and the memory utilization, the power consumption data points and the additional data points to form the training data set.

Example 5 includes the apparatus of example 4, wherein the server is an implementation of a first configuration of a device, the power consumption data points include one or more configurations of the device, the baseline model circuitry is to determine whether the one or more configurations from the power consumption data points includes a second configuration corresponding to the first configuration, and extrapolate, after a determination the power consumption data points include the second configuration, data points corresponding to the second configuration to produce the additional data points.

Example 6 includes the apparatus of example 4, wherein the server is an implementation of a first configuration of a device, the power consumption data points include one or more configurations of the device, the baseline model circuitry is to determine whether the one or more configurations from the power consumption data points includes a second configuration corresponding to the first configuration, and after a determination the power consumption data points do not include the second configuration identify a third configuration in the one or more configurations that is similar to the first configuration, select historical workload data points from the server that correspond to data points in the third configuration, shift the data points in the third configuration based on the workload data, and extrapolate the shifted data points to produce the additional data points.

Example 7 includes the apparatus of example 3, wherein the workload data includes a description of a historical workload executed by the server, and a recorded power consumption value corresponding to the execution of the historical workload.

Example 8 includes the apparatus of example 7, wherein to modify the training data set, the workload model circuitry is to identify a data point in the training data set with a workload description that matches the historical workload, and replace a first power consumption value corresponding to the data point with the recorded power consumption value.

Example 9 includes the apparatus of example 1, wherein the first candidate models includes the first prediction model and a third model, the apparatus further includes model executor circuitry to execute the first prediction model to produce a first output, and execute the third model to produce a third output, and to select the first prediction model from the first candidate models, the prediction selector circuitry is to compare the first output to an expected output to determine a first model error, compare the third output to the expected output to determine a third model error, and determine the first model error is less than or equal to the third model error.

Example 10 includes a non-transitory machine readable storage medium comprising instructions to cause programmable circuitry to at least divide a training data set into a first sub-range of data and a second sub-range of the data, a data point in the training data set representative of resource utilization of a workload and a corresponding power consumption metric of the workload, train first candidate models based on the first sub-range of the data and second candidate models based on the second sub-range of the data, select a first prediction model from the first candidate models, and select a second prediction model from the second candidate models, outputs of the first prediction model and the second prediction model to predict the power consumption of a server.

Example 11 includes the non-transitory machine readable storage medium of example 10, wherein the instructions cause the programmable circuitry to divide the training data set into a plurality of sub-ranges, ones of the sub-ranges corresponding to respective numbers of data points greater than or equal to a threshold value.

Example 12 includes the non-transitory machine readable storage medium of example 10, wherein the instructions cause the programmable circuitry to generate the training data set, and modify the training data set with workload data.

Example 13 includes the non-transitory machine readable storage medium of example 12, wherein to generate the training data set, the instructions cause the programmable circuitry to obtain power consumption data points from a manufacturer, the power consumption data points to describe expected power consumption based on a type of the server and a workload description, the workload description to include one or more of central processing unit (CPU) utilization and memory utilization, and extrapolate the power consumption data points to produce additional data points based on the type of the server, the CPU utilization, and the memory utilization, the power consumption data points and the additional data points to form the training data set.

Example 14 includes the non-transitory machine readable storage medium of example 13, wherein the server is an implementation of a first configuration of a device, the power consumption data points include one or more configurations of the device, the instructions cause the programmable circuitry to determine whether the one or more configurations from the power consumption data points includes a second configuration corresponding to the first configuration, and extrapolate, after a determination the power consumption data points include the second configuration, data points corresponding to the second configuration to produce the additional data points.

Example 15 includes the non-transitory machine readable storage medium of example 13, wherein the server is an implementation of a first configuration of a device, the power consumption data points include one or more configurations of the device, the instructions cause the programmable circuitry to determine whether the one or more configurations from the power consumption data points includes a second configuration corresponding to the first configuration, and after a determination the power consumption data points do not include the second configuration identify a third configuration in the one or more configurations that is similar to the first configuration, select historical workload data points from the server that correspond to data points in the third configuration, shift the data points in the third configuration based on the workload data, and extrapolate the shifted data points to produce the additional data points.

Example 16 includes the non-transitory machine readable storage medium of example 12, wherein the workload data includes a description of a historical workload executed by the server, and a recorded power consumption value corresponding to the execution of the historical workload.

Example 17 includes the non-transitory machine readable storage medium of example 16, wherein to modify the training data set, the instructions cause the programmable circuitry to identify a data point in the training data set with a workload description that matches the historical workload, and replace a first power consumption value corresponding to the data point with the recorded power consumption value.

Example 18 includes the non-transitory machine readable storage medium of example 10, wherein the first candidate models includes the first prediction model and a third model, the instructions cause the programmable circuitry to execute the first prediction model to produce a first output, and execute the third model to produce a third output, compare the first output to an expected output to determine a first model error, compare the third output to the expected output to determine a third model error, determine the first model error is less than or equal to the third model error, and select the first prediction model from the first candidate models based on the determination.

Example 19 includes a method to predict power consumption in a server, the method comprising dividing, by executing an instruction with programmable circuitry, a training data set into a first sub-range of data and a second sub-range of the data, a data point in the training data set representative of resource utilization of a workload and a corresponding power consumption metric of the workload, training, by executing an instruction with the programmable circuitry, first candidate models based on the first sub-range of the data and second candidate models based on the second sub-range of the data, selecting, by executing an instruction with the programmable circuitry, a first prediction model from the first candidate models, and selecting, by executing an instruction with the programmable circuitry, a second prediction model from the second candidate models, outputs of the first prediction model and the second prediction model to predict the power consumption of the server.

Example 20 includes the method of example 19, further including dividing, by executing an instruction with the programmable circuitry, the training data set into a plurality of sub-ranges, ones of the sub-ranges corresponding to respective numbers of data points greater than or equal to a threshold value.

Example 21 includes the method of example 19, further including generating, by executing an instruction with the programmable circuitry, the training data set, and modifying, by executing an instruction with the programmable circuitry, the training data set with workload data.

Example 22 includes the method of example 21, wherein generating the training data set further includes obtaining, by executing an instruction with the programmable circuitry, power consumption data points from a manufacturer, the power consumption data points to describe expected power consumption based on a type of the server and a workload description, the workload description to include one or more of central processing unit (CPU) utilization and memory utilization, and extrapolating, by executing an instruction with the programmable circuitry, the power consumption data points to produce additional data points based on the type of the server, the CPU utilization, and the memory utilization, the power consumption data points and the additional data points to form the training data set.

Example 23 includes the method of example 22, wherein the server is an implementation of a first configuration of a device, the power consumption data points include one or more configurations of the device, the method further including determining, by executing an instruction with the programmable circuitry, whether the one or more configurations from the power consumption data points includes a second configuration corresponding to the first configuration, and extrapolating, by executing an instruction with the programmable circuitry, after a determination the power consumption data points include the second configuration, data points corresponding to the second configuration to produce the additional data points.

Example 24 includes the method of example 22, wherein the server is an implementation of a first configuration of a device, the power consumption data points include one or more configurations of the device, the method further including determining, by executing an instruction with the programmable circuitry, whether the one or more configurations from the power consumption data points includes a second configuration corresponding to the first configuration, and after a determination the power consumption data points do not include the second configuration identifying, by executing an instruction with the programmable circuitry, a third configuration in the one or more configurations that is similar to the first configuration, selecting, by executing an instruction with the programmable circuitry, historical workload data points from the server that correspond to data points in the third configuration, shifting, by executing an instruction with the programmable circuitry, the data points in the third configuration based on the workload data, and extrapolating, by executing an instruction with the programmable circuitry, the shifted data points to produce the additional data points.

Example 25 includes the method of example 21, wherein the workload data includes a description of a historical workload executed by the server, and a recorded power consumption value corresponding to the execution of the historical workload.

Example 26 includes the method of example 25, wherein modifying the training data set further includes identifying, by executing an instruction with the programmable circuitry, a data point in the training data set with a workload description that matches the historical workload, and replacing, by executing an instruction with the programmable circuitry, a first power consumption value corresponding to the data point with the recorded power consumption value.

Example 27 includes the method of example 19, wherein the first candidate models includes the first prediction model and a third model, the method further including executing, by executing an instruction with the programmable circuitry, the first prediction model to produce a first output, and executing, by executing an instruction with the programmable circuitry, the third model to produce a third output, comparing, by executing an instruction with the programmable circuitry, the first output to an expected output to determine a first model error, comparing, by executing an instruction with the programmable circuitry, the third output to the expected output to determine a third model error, determining, by executing an instruction with the programmable circuitry, the first model error is less than or equal to the third model error, and selecting, by executing an instruction with the programmable circuitry, the first prediction model from the first candidate models based on the determination.

Example 28 includes an apparatus to predict power consumption in a server, the apparatus comprising means for dividing a training data set into a first sub-range of data and a second sub-range of the data, a data point in the training data set representative of resource utilization of a workload and a corresponding power consumption metric of the workload, means for training first candidate models based on the first sub-range of the data and second candidate models based on the second sub-range of the data, and means for selecting to select a first prediction model from the first candidate models, and select a second prediction model from the second candidate models, outputs of the first prediction model and the second prediction model to predict the power consumption of the server.

Example 29 includes the apparatus of example 28, wherein the means for dividing is further to divide the training data set into a plurality of sub-ranges, ones of the sub-ranges corresponding to respective numbers of data points greater than or equal to a threshold value.

Example 30 includes the apparatus of example 28, further including means for generating the training data set, and means for modifying the training data set with workload data.

Example 31 includes the apparatus of example 30, wherein to generate the training data set, the means for generating is to obtain power consumption data points from a manufacturer, the power consumption data points to describe expected power consumption based on a type of the server and a workload description, the workload description to include one or more of central processing unit (CPU) utilization and memory utilization, and extrapolate the power consumption data points to produce additional data points based on the type of the server, the CPU utilization, and the memory utilization, the power consumption data points and the additional data points to form the training data set.

Example 32 includes the apparatus of example 31, wherein the server is an implementation of a first configuration of a device, the power consumption data points include one or more configurations of the device, the means for generating is to determine whether the one or more configurations from the power consumption data points includes a second configuration corresponding to the first configuration, and extrapolate, after a determination the power consumption data points include the second configuration, data points corresponding to the second configuration to produce the additional data points.

Example 33 includes the apparatus of example 31, wherein the server is an implementation of a first configuration of a device, the power consumption data points include one or more configurations of the device, the means for generating is to determine whether the one or more configurations from the power consumption data points includes a second configuration corresponding to the first configuration, and after a determination the power consumption data points do not include the second configuration identify a third configuration in the one or more configurations that is similar to the first configuration, select historical workload data points from the server that correspond to data points in the third configuration, shift the data points in the third configuration based on the workload data, and extrapolate the shifted data points to produce the additional data points.

Example 34 includes the apparatus of example 30, wherein the workload data includes a description of a historical workload executed by the server, and a recorded power consumption value corresponding to the execution of the historical workload.

Example 35 includes the apparatus of example 34, wherein to modify the training data set, the means for modifying is to identify a data point in the training data set with a workload description that matches the historical workload, and replace a first power consumption value corresponding to the data point with the recorded power consumption value.

Example 36 includes the apparatus of example 28, wherein the first candidate models includes the first prediction model and a third model, the apparatus further includes means for executing to execute the first prediction model to produce a first output, and execute the third model to produce a third output, and to select the first prediction model from the first candidate models, the means for selecting is to compare the first output to an expected output to determine a first model error, compare the third output to the expected output to determine a third model error, and determine the first model error is less than or equal to the third model error.

1. An apparatus to predict power consumption in a server, the apparatus comprising:
interface circuitry to obtain a power prediction request corresponding to the server; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and first logic circuitry to perform one or more first operations corresponding to instructions, and one or more registers to store a first result of the one or more first operations, the instructions in the apparatus;
a Field Programmable Gate Array (FPGA), the FPGA including second logic gate circuitry, a plurality of configurable interconnections, and storage circuitry, the second logic gate circuitry and the plurality of the configurable interconnections to perform one or more second operations, the storage circuitry to store a second result of the one or more second operations; or
Application Specific Integrated Circuitry (ASIC) including logic gate circuitry to perform one or more third operations;
the processor circuitry to perform at least one of the first operations, the second operations, or the third operations to instantiate:
range determiner circuitry to divide a training data set into a first sub-range of data and a second sub-range of the data, a data point in the training data set representative of resource utilization of a workload and a corresponding power consumption metric of the workload;
model trainer circuitry to train first candidate models based on the first sub-range of the data and second candidate models based on the second sub-range of the data; and
prediction selector circuitry to:
select a first prediction model from the first candidate models; and
select a second prediction model from the second candidate models, outputs of the first prediction model and the second prediction model to predict the power consumption of the server.

2. The apparatus of claim 1, wherein the range determiner circuitry is further to divide the training data set into a plurality of sub-ranges, ones of the sub-ranges corresponding to respective numbers of data points greater than or equal to a threshold value.

3. The apparatus of claim 1, further including:
baseline model circuitry to generate the training data set; and
workload model circuitry to modify the training data set with workload data.

4. The apparatus of claim 3, wherein to generate the training data set, the baseline model circuitry is to:
obtain power consumption data points from a manufacturer, the power consumption data points to describe expected power consumption based on a type of the server and a workload description, the workload description to include one or more of central processing unit (CPU) utilization and memory utilization; and
extrapolate the power consumption data points to produce additional data points based on the type of the server, the CPU utilization, and the memory utilization, the power consumption data points and the additional data points to form the training data set.

5. The apparatus of claim 4, wherein the server is an implementation of a first configuration of a device, the power consumption data points include one or more configurations of the device, the baseline model circuitry is to:
determine whether the one or more configurations from the power consumption data points includes a second configuration corresponding to the first configuration; and
extrapolate, after a determination the power consumption data points include the second configuration, data points corresponding to the second configuration to produce the additional data points.

6. The apparatus of claim 4, wherein the server is an implementation of a first configuration of a device, the power consumption data points include one or more configurations of the device, the baseline model circuitry is to:
determine whether the one or more configurations from the power consumption data points includes a second configuration corresponding to the first configuration; and
after a determination the power consumption data points do not include the second configuration:
identify a third configuration in the one or more configurations that is similar to the first configuration;
select historical workload data points from the server that correspond to data points in the third configuration;
shift the data points in the third configuration based on the workload data; and
extrapolate the shifted data points to produce the additional data points.

7. The apparatus of claim 3, wherein the workload data includes:
a description of a historical workload executed by the server; and
a recorded power consumption value corresponding to the execution of the historical workload.

8. The apparatus of claim 7, wherein to modify the training data set, the workload model circuitry is to:
identify a data point in the training data set with a workload description that matches the historical workload; and
replace a first power consumption value corresponding to the data point with the recorded power consumption value.

9. The apparatus of claim 1, wherein:
the first candidate models includes the first prediction model and a third model;
the apparatus further includes model executor circuitry to:
execute the first prediction model to produce a first output; and
execute the third model to produce a third output; and
to select the first prediction model from the first candidate models, the prediction selector circuitry is to:
compare the first output to an expected output to determine a first model error;
compare the third output to the expected output to determine a third model error; and
determine the first model error is less than or equal to the third model error.

10. A non-transitory machine readable storage medium comprising instructions to cause programmable circuitry to at least:
divide a training data set into a first sub-range of data and a second sub-range of the data, a data point in the training data set representative of resource utilization of a workload and a corresponding power consumption metric of the workload;
train first candidate models based on the first sub-range of the data and second candidate models based on the second sub-range of the data;
select a first prediction model from the first candidate models; and
select a second prediction model from the second candidate models, outputs of the first prediction model and the second prediction model to predict the power consumption of a server.

11. The non-transitory machine readable storage medium of claim 10, wherein the instructions cause the programmable circuitry to divide the training data set into a plurality of sub-ranges, ones of the sub-ranges corresponding to respective numbers of data points greater than or equal to a threshold value.

12. The non-transitory machine readable storage medium of claim 10, wherein the instructions cause the programmable circuitry to:
generate the training data set; and
modify the training data set with workload data.

13. The non-transitory machine readable storage medium of claim 12, wherein to generate the training data set, the instructions cause the programmable circuitry to:
obtain power consumption data points from a manufacturer, the power consumption data points to describe expected power consumption based on a type of the server and a workload description, the workload description to include one or more of central processing unit (CPU) utilization and memory utilization; and
extrapolate the power consumption data points to produce additional data points based on the type of the server, the CPU utilization, and the memory utilization, the power consumption data points and the additional data points to form the training data set.

14. The non-transitory machine readable storage medium of claim 13, wherein the server is an implementation of a first configuration of a device, the power consumption data points include one or more configurations of the device, the instructions cause the programmable circuitry to:
determine whether the one or more configurations from the power consumption data points includes a second configuration corresponding to the first configuration; and
extrapolate, after a determination the power consumption data points include the second configuration, data points corresponding to the second configuration to produce the additional data points.

15. The non-transitory machine readable storage medium of claim 13, wherein the server is an implementation of a first configuration of a device, the power consumption data points include one or more configurations of the device, the instructions cause the programmable circuitry to:
determine whether the one or more configurations from the power consumption data points includes a second configuration corresponding to the first configuration; and
after a determination the power consumption data points do not include the second configuration:
identify a third configuration in the one or more configurations that is similar to the first configuration;
select historical workload data points from the server that correspond to data points in the third configuration;
shift the data points in the third configuration based on the workload data; and
extrapolate the shifted data points to produce the additional data points.

16. The non-transitory machine readable storage medium of claim 12, wherein the workload data includes:
a description of a historical workload executed by the server; and
a recorded power consumption value corresponding to the execution of the historical workload.

17. The non-transitory machine readable storage medium of claim 16, wherein to modify the training data set, the instructions cause the programmable circuitry to:
identify a data point in the training data set with a workload description that matches the historical workload; and
replace a first power consumption value corresponding to the data point with the recorded power consumption value.

18. The non-transitory machine readable storage medium of claim 10, wherein the first candidate models includes the first prediction model and a third model, the instructions cause the programmable circuitry to:
execute the first prediction model to produce a first output; and
execute the third model to produce a third output;
compare the first output to an expected output to determine a first model error;
compare the third output to the expected output to determine a third model error;
determine the first model error is less than or equal to the third model error; and
select the first prediction model from the first candidate models based on the determination.

19. A method to predict power consumption in a server, the method comprising:
dividing, by executing an instruction with programmable circuitry, a training data set into a first sub-range of data and a second sub-range of the data, a data point in the training data set representative of resource utilization of a workload and a corresponding power consumption metric of the workload;
training, by executing an instruction with the programmable circuitry, first candidate models based on the first sub-range of the data and second candidate models based on the second sub-range of the data;
selecting, by executing an instruction with the programmable circuitry, a first prediction model from the first candidate models; and
selecting, by executing an instruction with the programmable circuitry, a second prediction model from the second candidate models, outputs of the first prediction model and the second prediction model to predict the power consumption of the server.

20. The method of claim 19, further including dividing, by executing an instruction with the programmable circuitry, the training data set into a plurality of sub-ranges, ones of the sub-ranges corresponding to respective numbers of data points greater than or equal to a threshold value.

21. The method of claim 19, further including:
generating, by executing an instruction with the programmable circuitry, the training data set; and
modifying, by executing an instruction with the programmable circuitry, the training data set with workload data.

22. The method of claim 21, wherein generating the training data set further includes:
obtaining, by executing an instruction with the programmable circuitry, power consumption data points from a manufacturer, the power consumption data points to describe expected power consumption based on a type of the server and a workload description, the workload description to include one or more of central processing unit (CPU) utilization and memory utilization; and
extrapolating, by executing an instruction with the programmable circuitry, the power consumption data points to produce additional data points based on the type of the server, the CPU utilization, and the memory utilization, the power consumption data points and the additional data points to form the training data set.

23. The method of claim 22, wherein the server is an implementation of a first configuration of a device, the power consumption data points include one or more configurations of the device, the method further including:
determining, by executing an instruction with the programmable circuitry, whether the one or more configurations from the power consumption data points includes a second configuration corresponding to the first configuration; and
extrapolating, by executing an instruction with the programmable circuitry, after a determination the power consumption data points include the second configuration, data points corresponding to the second configuration to produce the additional data points.

24. The method of claim 22, wherein the server is an implementation of a first configuration of a device, the power consumption data points include one or more configurations of the device, the method further including:
determining, by executing an instruction with the programmable circuitry, whether the one or more configurations from the power consumption data points includes a second configuration corresponding to the first configuration; and
after a determination the power consumption data points do not include the second configuration:
identifying, by executing an instruction with the programmable circuitry, a third configuration in the one or more configurations that is similar to the first configuration;
selecting, by executing an instruction with the programmable circuitry, historical workload data points from the server that correspond to data points in the third configuration;
shifting, by executing an instruction with the programmable circuitry, the data points in the third configuration based on the workload data; and
extrapolating, by executing an instruction with the programmable circuitry, the shifted data points to produce the additional data points.

25. The method of claim 21, wherein the workload data includes:
a description of a historical workload executed by the server; and
a recorded power consumption value corresponding to the execution of the historical workload.

26. The method of claim 25, wherein modifying the training data set further includes:
identifying, by executing an instruction with the programmable circuitry, a data point in the training data set with a workload description that matches the historical workload; and
replacing, by executing an instruction with the programmable circuitry, a first power consumption value corresponding to the data point with the recorded power consumption value.

27. The method of claim 19, wherein the first candidate models includes the first prediction model and a third model, the method further including:
executing, by executing an instruction with the programmable circuitry, the first prediction model to produce a first output; and
executing, by executing an instruction with the programmable circuitry, the third model to produce a third output;
comparing, by executing an instruction with the programmable circuitry, the first output to an expected output to determine a first model error;
comparing, by executing an instruction with the programmable circuitry, the third output to the expected output to determine a third model error;
determining, by executing an instruction with the programmable circuitry, the first model error is less than or equal to the third model error; and
selecting, by executing an instruction with the programmable circuitry, the first prediction model from the first candidate models based on the determination.

28.-36. (canceled)
